(19) United States
(12) Patent Application Publication
(10) Pub. No.: US 2011/0179009 A1
(43) Pub. Date: Jul. 21, 2011

(54) INTERNET-BASED OPINION SEARCH SYSTEM AND METHOD, AND INTERNET-BASED OPINION SEARCH AND ADVERTISING SERVICE SYSTEM AND METHOD

(76) Inventor: Sang Hyob Nam, Gyeongsangbuk-do (KR)

(21) Appl. No.: 13/120,649

(22) PCT Filed: Sep. 23, 2009
(86) PCT No.: PCT/KR2009/005405

§ 371 Date: Mar. 23, 2011

(30) Foreign Application Priority Data
Sep. 23, 2008 (KR) 10-2008-0093125
Oct. 1, 2008 (KR) 10-2008-0096415

(51) Int. Cl. G06F 17/30; G06Q 30/00

(52) U.S. Cl. 707/708; 705/14.54; 707/E17.108

(57) ABSTRACT

The present invention relates to an Internet-based opinion search system and an opinion search and advertisement service system and method for same, wherein user opinion information scattered across various websites existing on the Internet is automatically extracted and analyzed to provide opinion search services so that search and statistical results may be checked based on affirmative/negative opinions, and also provides appropriate custom advertisement services to individual opinion search users in addition to user opinion information scattered across various websites on the Internet so that: opinion search users may easily and quickly search and monitor the opinions of other users with respect to a specific keyword, substantial amount of time formerly spent searching for opinions of other users may be greatly reduced, opinions of other users with respect to a specific keyword may be searched and monitored easily and quickly from the standpoint of an opinion search user, and more efficient advertisement effects can be obtained regarding the goods from the standpoint of a sponsor, which can effectively improve the probability of purchase of goods.

### TECHNICAL FIELD

The present invention relates to an Internet-based opinion search system and method and an Internet-based opinion search and advertising service system and method, and more particularly, to an Internet-based opinion search system and method and an Internet-based opinion search and advertising service system and method, wherein user opinion information scattered across various websites on the Internet is automatically extracted and analyzed to provide an opinion search service so that search and statistical results can be checked according to affirmative/negative opinions, and an appropriate custom advertising service for each opinion search user is simultaneously provided together with the user opinion information scattered across various websites on the Internet so that users and opinion search users can easily and quickly search and monitor opinions of other users about a specific keyword, and advertisers can obtain efficient advertising effects on their products and also increase the probability of purchasing the products.

### BACKGROUND ART

As use of the Internet has been increasing lately, many people are posting their opinions on the Internet through media, for example, blogs and wikis. Also, the need to refer to opinion information uploaded by others on the Internet in order to evaluate specific information is increasing.

For example, there are various user opinions ranging from product reviews to movie reviews on the Internet. Such respective user opinions can be used when general users want other users' opinions before purchasing products or seeing movies, and also when marketers, stock traders, etc. want various opinions of general users about respective products or companies. In particular, general users tend to purchase a specific product after seeing other users' reviews.

In other words, a case in which a user wants to know other users' opinions frequently corresponds to a step before purchasing a product rather than a case of a general search. When advertisements for related products are effectively provided to the user in this step, the effect further increases.

However, opinions on the Internet are only in individual websites, and thus a user should manually search all the individual websites one by one to use the opinions.

It is difficult for users to search all such websites. Also, it is difficult to effectively search for other users' opinions through a general search because web documents with opinions, web documents with affirmative opinions, web documents with negative opinions, etc. coexist.

### Technical Problem

The present invention is directed to an Internet-based opinion search system and method wherein user opinion information scattered across various websites on the Internet is automatically extracted and analyzed to provide an opinion search service so that search and statistical results can be checked according to affirmative/negative opinions, and thereby users can easily and quickly search and monitor other users' opinions about a specific keyword.

The present invention is directed to an Internet-based opinion search and advertising service system and method wherein an appropriate custom advertising service for each opinion search user is simultaneously provided together with user opinion information scattered across various websites on the Internet so that opinion search users can easily and quickly search and monitor other users' opinions about a specific keyword, and advertisers can obtain efficient advertising effects on their products and also increase the probability of purchasing the products.

### Technical Solution

One aspect of the present invention provides an Internet-based opinion search system, including: a first server configured to collect web document data on the Internet; a language processing module configured to split the collected web document data according to sentences, and extract linguistic features by performing a language process on respective sentences; an opinion/non-opinion classification module configured to classify the sentences into opinion/non-opinion sentences using the extracted linguistic features of the respective sentences; an opinion expression classification module configured to classify the linguistic features of the classified opinion sentences into affirmative/negative opinion expressions; a second server configured to index the classified opinion sentences to store opinion information of the corresponding web documents according to the linguistic features of the classified opinion sentences; and a web server configured to receive a specific keyword transmitted from a user terminal having accessed the second server via the Internet, search for opinion information of web documents relating to the specific keyword in association with the second server, and display opinion search results on a screen of the user terminal.

Here, the Internet-based opinion search system may further include a data storage module configured to extract at least one piece of information data among required text, image and video information from the web document data collected by the first server and store the extracted data.

The language processing module may split general document data including previously-set opinion/non-opinion sentences together with the collected web document data according to sentences, and extract linguistic features by performing a language process on respective sentences.

The Internet-based opinion search system may further include an opinion indexing information storage module configured to store summarized information about the opinion sentences according to the linguistic features of the respective opinion sentences indexed by the second server and base information and the opinion information of the web documents as a database (DB).

The base and opinion information of the web documents may include at least one piece of information among titles, text, opinion-analyzed text, generation dates, tags, uniform resource locators (URLs), images, motion pictures, the number of affirmative/negative expressions, the overall degree of affirmation/negation, position information about a start and end of each affirmative/negative expression, keyword information about an entity likely to be a target of opinion words, information about a relationship between an entity keyword and an opinion expression, and type information about respective entity keywords.

The language process may be morpheme analysis or a segmentation process.

The web server may display all opinions and affirmative/negative opinion content relating to the specific keyword on the screen of the user terminal to enable selective check of all of the opinions and the affirmative/negative opinion content.

The web server may display an affirmative/negative opinion expression ratio in all the opinion search results relating to the specific keyword or in each piece of the opinion information relating to the specific keyword on the screen of the user terminal.

The web server may list the opinion search results relating to the specific keyword in order of importance or time and display the list on the screen of the user terminal.

The importance may be determined according to the degree of relationship and the degree of opinion expressions that the specific keyword has in the web documents and applied within an entire time range or a specific time range, and the time order may be determined in ascending/descending order according to a sequence in which the web documents are generated and applied within the entire time range or the specific time range.

The web server may display an opinion input window on the screen of the user terminal to enable the corresponding opinion search user to add an opinion about opinion content of the web documents relating to the specific keyword as a comment.

The web server may display the opinion search results relating to the specific keyword on the screen of the user terminal with the specific keyword and affirmative/negative opinion expressions emphasized by a particular feature.

The web server may analyze affirmative/negative opinion expressions of opinion search result text relating to the specific keyword according to a selection of the corresponding user, and display the opinion search result text on the screen of the user terminal with the affirmative/negative opinion expressions emphasized by a particular feature.

The particular feature may be at least one emphatic feature among an underline, bold letter type, and various colors.

The web server may display period-specific variation in affirmation/negation ratio of the opinion search results relating to the specific keyword in the form of a graph according to the degree of affirmative/negative opinion expressions on the screen of the user terminal.

The web server may display an affirmation/negation ratio of the opinion search results relating to the specific keyword according to sub-themes of the specific keyword on the screen of the user terminal.

The web server may display agree/disagree buttons on the screen of the user terminal to enable the corresponding user to select agree/disagree with opinion search result text relating to the specific keyword.

The web server may monitor and report generation of affirmative/negative opinions relating to the specific keyword having been registered by the user to the user terminal in real time.

Another aspect of the present invention provides an Internet-based opinion search method, including: (a) collecting web document data on the Internet; (b) splitting the collected web document data according to sentences, and performing a language process on the respective sentences to extract linguistic features; (c) classifying the sentences into opinion/non-opinion sentences using the extracted linguistic features of the respective sentences; (d) classifying linguistic features of the classified opinion sentences into affirmative/negative opinion expressions; (e) indexing the classified opinion sentences to store opinion information of the corresponding web documents according to the linguistic features of the classified opinion sentences; and (f) searching for opinion information of web documents relating to a specific keyword transmitted from a user terminal having been accessed via the Internet, and displaying opinion search results on a screen of the user terminal.

Step (b) may include splitting general document data including predetermined opinion/non-opinion sentences according to sentences together with the collected web document data, and extracting linguistic features by performing a language process on respective sentences.

Step (e) may include storing summarized information about the opinion sentences according to the linguistic features of the indexed respective opinion sentences and base information and the opinion information of the corresponding web documents as a DB in a storage module.

Step (b) may include performing morpheme analysis or a segmentation process as the language process.

Step (f) may include displaying all opinions and affirmative/negative opinion content relating to the specific keyword to enable selective check of all of the opinions and the affirmative/negative opinion content when the opinion search results relating to the specific keyword are displayed on the screen of the user terminal.

Step (f) may include displaying an affirmative/negative opinion expression ratio in all the opinion search results relating to the specific keyword or in each piece of the opinion information relating to the specific keyword on the screen of the user terminal when the opinion search results relating to the specific keyword are displayed on the screen of the user terminal.

Step (f) may include displaying the opinion search results relating to the specific keyword in order of importance or time when the opinion search results relating to the specific keyword are displayed on the screen of the user terminal.

The importance may be determined according to the degree of relationship and the degree of opinion expressions that the specific keyword has in the web documents and applied within an entire time range or a specific time range, and the time order may be determined in ascending/descending order according to a sequence in which the web documents are generated and applied within the entire time range or the specific time range.

Step (f) may include displaying an opinion input window to enable the corresponding opinion search user to add an opinion about opinion content of the web documents relating to the specific keyword as a comment when the opinion search results relating to the specific keyword are displayed on the screen of the user terminal.

Step (f) may include displaying the opinion search results relating to the specific keyword with the specific keyword and affirmative/negative opinion expressions emphasized by a particular feature when the opinion search results relating to the specific keyword are displayed on the screen of the user terminal.

The particular feature may be at least one emphatic feature among an underline, bold letter type, and various colors.

Step (f) may include, when the opinion search results relating to the specific keyword are displayed on the screen of the user terminal, analyzing affirmative/negative opinion expressions of opinion search result text relating to the specific keyword according to a selection of the corresponding user, and then displaying the opinion search results relating to the specific keyword with the affirmative/negative opinion expressions emphasized by a particular feature.

Step (f) may include displaying period-specific variation in affirmation/negation ratio in the form of a graph according to the degree of affirmative/negative opinion expressions when the opinion search results relating to the specific keyword are displayed on the screen of the user terminal.

Step (f) may include displaying an affirmation/negation ratio according to sub-themes of the specific keyword when the opinion search results relating to the specific keyword are displayed on the screen of the user terminal.

The Internet-based opinion search method may further include, after step (f), monitoring and reporting generation of affirmative/negative opinions relating to the specific keyword having been registered by a user to the user terminal in real time.

Still another aspect of the present invention provides a recording medium storing a program for executing the Internet-based opinion search method.

Yet another aspect of the present invention provides an Internet-based opinion search and advertising service system, including: an opinion information DB configured to store opinion information of the corresponding web documents according to linguistic features of opinion sentences; an advertising information DB configured to store keyword-specific advertising information; and a web server configured to receive a specific keyword transmitted from a user terminal having accessed the web server via the Internet, search for opinion information of web documents relating to the specific keyword and advertising information relating to the specific keyword in association with the opinion information DB and the advertising information DB, and display the related advertising information together with opinion search result text on a screen of the user terminal.

Here, summarized information about the opinion sentences according to the linguistic features of the respective opinion sentences and base information and the opinion information of the web documents may be stored as a DB in the opinion information DB.

The base and opinion information of the web documents may include at least one piece of information among titles, text, opinion-analyzed text, generation dates, tags, URLs, images, motion pictures, the number of affirmative/negative expressions, the overall degree of affirmation/negation, position information about a start and end of each affirmative/negative expression, keyword information about an entity likely to be a target of opinion words, information about a relationship between an entity keyword and an opinion expression, and type information about respective entity keywords.

The opinion information stored in the opinion information DB may be obtained by splitting web document data on the Internet according to sentences, performing a language process on respective sentences to extract linguistic features, classifying the sentences into opinion/non-opinion sentences using the extracted linguistic features of the respective sentences, classifying the linguistic features of the classified opinion sentences into affirmative/negative opinion expressions, and indexing the opinion information of the corresponding web documents according to the linguistic features of the classified opinion sentences.

The language process may be morpheme analysis or a segmentation process.

At least one piece of advertising information among advertising link, advertising phrase, and advertising image information according to search keywords previously set by advertisers, the search result keywords, or resultant keywords of opinion search types may be databased and stored as the advertising information.

The opinion search types may be one selected from all opinion content, affirmative/negative opinion content, and analysis content of affirmative/negative opinion expressions of the opinion search result text.

The web server may display all opinions and affirmative/negative opinion content relating to the specific keyword on the screen of the user terminal to enable selective check of all of the opinions and the affirmative/negative opinion content, and may display the related advertising information on the screen of the user terminal together with an affirmative/negative opinion expression ratio in all opinion search results relating to the specific keyword or in each piece of the opinion information relating to the specific keyword.

The web server may display the related advertising information on the screen of the user terminal together with the affirmative opinion content relating to the specific keyword, or display an input window on the screen of the user terminal to enable the corresponding search user to provide an explanation for the negative opinion content of the web documents relating to the specific keyword.

The web server may analyze affirmative/negative opinion expressions of the opinion search result text relating to the specific keyword according to a selection of the corresponding user, and display the related advertising information on the screen of the user terminal together with the analyzed opinion expressions.

The web server may provide a part of advertising revenue to a content provider who provides the opinion search result text according to a search ranking of the corresponding content, whether or not a search user selects the content, and the number of recommendations on the content.

Yet another aspect of the present invention provides an Internet-based opinion search and advertising service method, including: (a) storing opinion information of the corresponding web documents in an opinion information DB according to linguistic features of opinion sentences; (b) storing keyword-specific advertising information in an advertising information DB; and (c) searching the opinion information DB and the advertising information DB for opinion information of web documents and advertising information relating to a specific keyword transmitted from a user terminal having been accessed via the Internet, and displaying the related advertising information together with opinion search result text on a screen of the user terminal.

Step (a) may include storing summarized information about the opinion sentences according to the linguistic features of the respective opinion sentences and base information and the opinion information of the corresponding web documents as a DB in the opinion information DB.

Step (a) may include splitting web document data on the Internet according to sentences, performing a language process on respective sentences to extract linguistic features, classifying the sentences into opinion/non-opinion sentences using the extracted linguistic features of the respective sentences, classifying the linguistic features of the classified opinion sentences into affirmative/negative opinion expressions, indexing the opinion information of the web documents according to the linguistic features of the classified opinion sentences, and storing the opinion information in the opinion information DB.

Step (b) may include storing at least one piece of advertising information among advertising link, advertising phrase, and advertising image information according to search keywords previously set by advertisers, the search result keywords, or resultant keywords of opinion search types as a DB in the advertising information DB.

The opinion search types may be one selected from all opinion content, affirmative/negative opinion content, and analysis content of affirmative/negative opinion expressions of the opinion search result text.

Step (c) may include, when the related advertising information is displayed on the screen of the user terminal together with the opinion search result text relating to the specific keyword, displaying all opinions and affirmative/negative opinion content relating to the specific keyword on the screen of the user terminal to enable selective check of all of the opinions and the affirmative/negative opinion content, and displaying the related advertising information on the screen of the user terminal together with an affirmative/negative opinion expression ratio in all opinion search results relating to the specific keyword or in each piece of the opinion information relating to the specific keyword.

Step (c) may include, when the related advertising information is displayed on the screen of the user terminal together with the opinion search result text relating to the specific keyword, displaying the related advertising information on the screen of the user terminal together with the affirmative opinion content relating to the specific keyword, or displaying an input window on the screen of the user terminal to enable the corresponding search user to provide an explanation for the negative opinion content of the web documents relating to the specific keyword.

Step (c) may include, when the related advertising information is displayed on the screen of the user terminal together with the opinion search result text relating to the specific keyword, analyzing affirmative/negative opinion expressions of the opinion search result text relating to the specific keyword according to a selection of the corresponding user, and displaying the related advertising information on the screen of the user terminal together with the analyzed opinion expressions.

The Internet-based opinion search and advertising service method may further include, after step (c), providing a part of advertising revenue to a content provider who provides the opinion search result text according to a search ranking of the corresponding content, whether or not a search user selects the content, and the number of recommendations on the content.

Yet another aspect of the present invention provides a recording medium storing a program for executing the Internet-based opinion search and advertising service method.

### Advantageous Effects

An Internet-based opinion search system and method according to an exemplary embodiment of the present invention automatically extract and analyze user opinion information scattered across various websites on the Internet to provide an opinion search service so that search and statistical results can be checked according to affirmative/negative opinions. Thus, users can easily and quickly search and monitor other users' opinions about a specific keyword, and remarkably reduce the time conventionally taken to search for other users' opinions.

An exemplary embodiment of the present invention enables marketers, stock traders, firm valuators, etc. to quickly check various users' opinions about the corresponding company or products on the vast Internet, and can effectively extract opinions of respective users and develop and use statistics on the opinions while remarkably reducing the cost required for a consulting company or a survey conventionally carried out to know users' opinions.

An exemplary embodiment of the present invention provides an appropriate custom advertising service for each opinion search user together with user opinion information scattered across various websites on the Internet so that opinion search users can easily and quickly search and monitor other users' opinions about a specific keyword, and advertisers can obtain efficient advertising effects on their products and also increase the probability of purchasing products.

An exemplary embodiment of the present invention enables a user to purchase something after checking information about affirmative opinions on an aspect of it that the user is interested in, using a search and statistics showing opinion-oriented information relating to purchase of it and advertisements caused by the search and statistics. Thus, much time conventionally taken to search for other users' opinions can be remarkably reduced.

### DESCRIPTION OF DRAWINGS

FIG. 1 is an overall block diagram of an Internet-based opinion search system according to an exemplary embodiment of the present invention.

FIG. 2 is an overall flowchart illustrating an Internet-based opinion search method according to an exemplary embodiment of the present invention.

FIGS. 3 to 6 show screens for describing opinion search results applied to an exemplary embodiment of the present invention, FIG. 3 showing a screen displaying opinion search results when a specific opinion search keyword “Nom nom nom” and an affirmative opinion type are selected, FIG. 4 showing a screen displaying opinion search results when a specific opinion search keyword “Nom nom nom” and a negative opinion type are selected, FIG. 5 showing details of an opinion-analyzed page function for opinion search result text relating to a specific opinion search keyword “Nom nom nom,” and FIG. 6 showing a screen having agree/disagree buttons enabling a user to select agree/disagree with opinion search result text relating to a specific keyword “Nom nom nom.”

FIG. 7 is an overall block diagram of an Internet-based opinion search and advertising service system according to another exemplary embodiment of the present invention.

FIG. 8 is an overall flowchart illustrating an Internet-based opinion search and advertising service method according to another exemplary embodiment of the present invention.

FIGS. 9 to 12 show screens for describing opinion search and advertising service results applied to another exemplary embodiment of the present invention.

### MODE FOR INVENTION

Hereinafter, exemplary embodiments of the present invention will be described in detail. However, the present invention is not limited to the exemplary embodiments disclosed below, but can be implemented in various types. Therefore, the present exemplary embodiments are provided for complete disclosure of the present invention and to fully inform the scope of the present invention to those ordinarily skilled in the art.

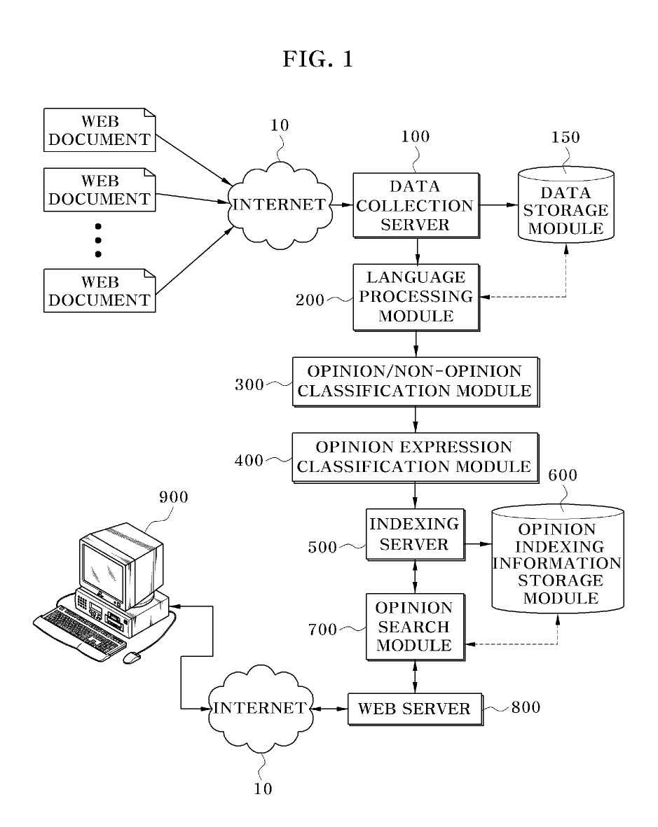

FIG. 1 is an overall block diagram of an Internet-based opinion search system according to an exemplary embodiment of the present invention.

Referring to FIG. 1, an Internet-based opinion search system according to an exemplary embodiment of the present invention schematically includes a data collection server 100, a language processing module 200, an opinion/non-opinion classification module 300, an opinion expression classification module 400, an indexing server 500, an opinion indexing information storage module 600, an opinion search module 700, a web server 800, a user terminal 900, and so on.

Here, the data collection server 100 serves to collect web document data on the Internet 10. In other words, the data collection server 100 downloads hyper text markup language (HTML) information of each website on the Internet 10 in real time.

Also, the data collection server 100 may extract at least one piece of information data among pieces of required information, for example, text, image, video, etc. information, from the downloaded web document data and store the extracted information data in a data storage module 150.

Further, the data collection server 100 may selectively collect web document data including opinion information data (i.e., general sentence/document data and information data in which affirmative/negative evaluations of the general sentence/document data are made), as shown in Table 1 below.

Here, in a method of selectively collecting only web document data including opinion information data, specific web document data including opinion information data is selected, a web document selection model is generated using a machine learning classifier algorithm (e.g., support vector machine (SVM), K-nearest neighbors (K-NN), and Bayesian) to be described later, and then only web document data including opinion information data can be selectively collected from entire Internet web pages using the generated web document selection model.

Lately, the amount of review/opinion text about movies that users have seen, products that users have purchased, celebrities, national policies, etc. is drastically increasing. Data shown in Table 1 shows common comments about movies.

As shown in Table 1, a pair of available data (sentence/document and affirmation/negation scores) is significantly increasing. Such an increase of web document data contributes greatly to the automatic construction of an opinion vocabulary dictionary and the development of an opinion extraction system.

TABLE 1

| Expression | Score | Opinion |
|---|---|---|
| ★★★★★ | 10 | Interesting report |
| ★★★★★ | 10 | A story of “smart” people's living report |
| ★★★★★ | 8 | Wise people reconstruct their daily lives! report |
| ★★★★★ | 9 | You will be mesmerized by the uncle's charm report |
| ★★★★★ | 8 | A story of ordinary people rather than smart people report |
| ★★★★★ | 10 | Excellent acting, interesting content, and a heartwarming love story. How |
| | | charming the uncle is~???? report |
| ★★★★★ | 10 | It was a deeply touching story report |
| ★★★★★ | 10 | I saw it with little expectations, but the entire film warmed my heart. Also, |
| | | it was interesting report |
| ★★★★ | 6 | It was warm and comic . . . I felt like it was too short . . . But, what if the uncle |
| | | hadn't been there???? report |
| ★★★ | 5 | Repeat, repeat, repeat, and the same story after all. report |

As shown in Table 1, entity data collected by the data collection server 100 is opinion information data, that is, general sentence/document data and information data in which affirmative/negative evaluations of the general sentence/document data are made.

Here, the affirmative/negative evaluations may be expressed by a score within a predetermined range, or in various ways using stars ★ or other marks. In an exemplary embodiment of the present invention, all affirmative/negative evaluations expressed in various ways are recalculated within the same score range and used.

To be specific, when a score range used in an exemplary embodiment of the present invention is from a to b and a score range of collected data is from c to d, a collection score x is changed as shown in Equation 1 below.

$$PolarityScore ( x ) = ( a - 1 ) + \frac{x - c + 1}{d - c + 1} \times ( b - a + 1 ) \qquad Equation 1$$

As an example, a score of 1 to 10 (the closer to 10, the more affirmative) is used in an exemplary embodiment of the present invention and a score of 1 to 5 is used by collected data. In this case, when collected data has a score of 2, the score is changed as shown in Equation 2 below.

$$PolarityScore ( 2 ) = ( 1 - 1 ) + \frac{2 - 1 + 1}{5 - 1 + 1} \times ( 10 - 1 + 1 ) = 4 \qquad Equation 2$$

As another example, when a score of 1 to 10 is used in an exemplary embodiment of the present invention and a score of 1 to 20 is used by collected data, the score is changed as shown in Equation 3 below.

$$PolarityScore ( 2 ) = ( 1 - 1 ) + \frac{2 - 1 + 1}{20 - 1 + 1} \times ( 10 - 1 + 1 ) = 1 \qquad Equation 3$$

Data collected as mentioned above becomes a set of opinion scores {(data, score), (data, score), (data, score), (data, score)} converted into a score used in an exemplary embodiment of the present invention together with the corresponding data sentence/text.

Meanwhile, web document data collected by the data collection server 100 can be directly used as mentioned above, and also can be used after being classified according to respective domains using a domain classification module (not shown).

To be specific, first, data relating to domains to be classified (e.g., movies, books, electronics, cosmetics, clothing, and persons) is collected according to the respective domains to secure data according to the domains.

At this time, data collected according to each domain consists of a combination of review data and fact data about the corresponding domain. All review-data-to-fact-data ratios of the data collected according to the respective domains are maintained to be the same or similar, so that the data can be classified according to only the domains.

Next, a language process is performed to extract appropriate features of the respective domains from the collected domain data. At this time, in the language process, the data is split into semantically-separable units by morpheme analysis or segmentation.

Meanwhile, features of the respective domains input to a machine learning model to be described later are as follows.

For example, when input data from a domain relating to books is [symbol] [symbol] A [symbol] [symbol] [symbol] the data is converted by segmentation into [symbol] A [symbol] [symbol] [symbol] and converted by morpheme analysis into [symbol] (CTP3; third person pronoun)+ [symbol] (fjb; auxiliary postposition [symbol] (CMCN; non-predicative common noun) A(F; foreign letter) [symbol] (UM; estimated as uninflected word)+ [symbol] (fjcao; general adverbial postposition) [symbol] (CMCPA; active-predicative common noun)+ [symbol] (fph; adjective-derivational affix)+ [symbol] (fmoca; auxiliary conjunctive ending) [symbol] (CMCN; non-predicative common noun)+ [symbol] (fjeo; objective postposition) [symbol] (CMCN; non-predicative common noun)+ [symbol] (fpd; verb-derivational affix)+ [symbol] (fmbtp; past-tense pre-final ending)+ [symbol] (fmofd; declarative final ending)+.(g; mark).”

When only the data having undergone segmentation is used, features of the domain are as follows.
\textcircled{1} Unigram: [symbol] A, [symbol] [symbol] [symbol]
=>a b c d e->a, b, c, d, e
\textcircled{2} Bigram: [symbol] [symbol] A, A [symbol] [symbol] [symbol] [symbol] [symbol]
=>a b c d e->a b, b c, c d, d e
\textcircled{3} Trigram: [symbol] A, [symbol] A [symbol] [symbol] [symbol] [symbol] [symbol] [symbol]
=>a b c d e->a b c, b c d, c d e

Meanwhile, when the data having undergone morpheme analysis is used, features of the domain are as follows. In other words, after a postposition, affix, pre-final ending, final ending, etc. determined to have no specific meaning through morpheme analysis are removed, features in the form of unigram, bigram and trigram can be used as the data having undergone segmentation.

Unigram: [symbol] A,

[symbol]

\textcircled{2} Bigram: [symbol] A, A

[symbol]

[symbol]

\textcircled{3} Trigram: [symbol] A, [symbol] A [symbol] A

[symbol]

[symbol]

As mentioned above, all of the unigram, bigram, and trigram features can be used, or only a part of the features can be selectively used. In this case, a combination showing the highest performance in evaluation using evaluation data is selected.

Subsequently, the domain-specific features are learned in the form of probability using, for example, naive Bayesian, SVM, K-NN, or another general machine learning classifier algorithm.

For example, a linear classifier can be expressed by Equation 4 below.

$$y = f ( \vec{w} \cdot \vec{x} ) = f ( {\sum }_{j} {w}_{j} {x}_{j} ) \qquad Equation 4$$

Here, \vec{χ} is an input data vector, which corresponds to a selected unigram, bigram, and trigram input data in an exemplary embodiment of the present invention. The input data vector \vec{χ} is constructed using information such as a frequency, presence or absence, etc. of each feature.

A magnitude of the vector is a frequency of entire features. Features not shown in the corresponding document have a value of 0, and features shown in the corresponding document have their frequencies or a value of 1.

Thus, \vec{χ} is expressed as a feature vector, for example, [0, 0, 1, 1, 0, 0, 0, 0, 0, 0, 1, . . . ].

Meanwhile, \vec{ω} is a weight vector, whereby weights are given to respective features according to respective classes. A matrix size is the number of types of the features×the number of the classes.

When learning is performed in this way, a value of \vec{ω} can be estimated. After the value of \vec{ω} is estimated, it is possible to know which class has the highest value by performing a matrix operation on \vec{ω} and \vec{χ} when \vec{χ} is input.

Also, in a machine learning classifier algorithm, data can be used as described above. To be specific, for example, a naive Bayesian classifier algorithm can be expressed by Equation 5 below.

$$p ( C \vert {F}_{1} , … , {F}_{n} ) = \frac{p ( C ) p ( {F}_{1} , … , {F}_{n} \vert C )}{p ( {F}_{1} , … , {F}_{n} )} \qquad Equation 5$$

Here, C denotes a class, which corresponds to a domain such as movies, books, and products. Fᵢ denotes each feature, which corresponds to, for example, a unigram [symbol] a bigram [symbol] and a trigram [symbol] A).

P(C) is a probability of class C occurring. For example, when the number of pieces of movie data is 5, that of pieces of book data is 12, and that of pieces of product data is 8, P(movie) is equal to “5/(5+12+8).”

P(F₁, . . . , Fₙ) is a probability of F₁, . . . , and Fₙ simultaneously occurring. P(F₁, . . . , Fₙ) is applied to all classes as a denominator and thus can be omitted. P(F₁, . . . , Fₙ|C) is a probability that F₁, . . . , and Fₙ will be generated when class C is given.

Numerators whereby a class probability is substantially determined in Equation 5 above are calculated by Equation 6 below on the assumption that the respective features are conditionally independent from each other.

$$\begin{matrix}p ( C , {F}_{1} , … , {F}_{n} ) = p ( C ) p ( {F}_{1} \vert C ) p ( {F}_{2} \vert C ) p ( {F}_{3} \vert C ) … \\ = p ( C ) {\prod }_{i = 1}^{n} p ( {F}_{i} \vert C ) .\end{matrix} \qquad Equation 6$$

Here, p(Fᵢ|C) is a probability of Fᵢ when a C is given, which can be calculated as

$$\frac{Freq ( {F}_{i} \vert C )}{{\sum }_{i = f}^{n} Freq ( {F}_{j} \vert C )} .$$

Freq(Fⱼ|C) denotes a frequency of features Fⱼ in class C. A frequency of the entire features is N.

By inputting the features to machine learning classifier algorithms as well as the naive Bayesian classifier algorithm, a model whereby class C is determined according to input data can be generated.

Finally, when the learning is finished as described above, one classification model is generated. When a sentence or document is input, the generated classification model determines in which domain the corresponding data is included in the form of probability.

Meanwhile, when a sentence or document is input while a classification model is actually used, features of the corresponding input data are selected in the same way as in the above example.

Subsequently, when features of the input data are input to the classification model, the classification model outputs class C showing the highest generation probabilities of the features.

As mentioned above, in an exemplary embodiment of the present invention, a dictionary can be automatically constructed using the domain classification module when opinions are extracted by the opinion/non-opinion classification module 300 to be described later.

Also, using the domain classification module, a learning model for the opinion expression classification module 400, which will be described later, to distinguish opinion expressions can be automatically generated.

Thus, when a learning model is generated by classifying data according to respective domains, a model for extracting opinions having performance optimized for a domain can be automatically generated.

Meanwhile, the Internet 10 denotes a worldwide public computer network structure providing transmission control protocol/Internet protocol (TCP/IP) and various services of upper layers, such as hyper text transfer protocol (HTTP), telnet, file transfer protocol (FTP), domain name system (DNS), simple mail transfer protocol (SMTP), simple network management protocol (SNMP), network file service (NFS), and network information service (NIS), and the user terminal 900 provides an environment enabling easy access to the web server 800 to be described later. The Internet 10 may be the wired or wireless Internet, or a core network combined with a wired public network, a wireless mobile communication network, the mobile Internet, or so on.

The language processing module 200 serves to split web document data collected by the data collection server 100 or stored in the data storage module 150 according to sentences, and to extract linguistic features by performing a language process on respective split sentences.

Also, the language processing module 200 may split general document data (e.g., a text, Hangul, word processor, or Excel document) as well as the web document data collected by the data collection server 100 or stored in the data storage module 150 according to sentences, and extract linguistic features by performing a language process on respective split sentences.

Meanwhile, the general document data may include an opinion/non-opinion classification model whereby the corresponding data can be correctly determined as review data or fact data, that is, opinion and/or non-opinion sentences previously set to implement the opinion/non-opinion classification module 300. Thus, limited web document data can be effectively complemented.

Here, the language process may be, for example, morpheme analysis or a segmentation process. Additionally, the language process may be postposition processing for extracting features (or indexes), processing of Korean inflection, processing for restoration of an original form, or so on.

The opinion/non-opinion classification module 300 serves to classify opinion/non-opinion sentences using the linguistic features of the respective sentences extracted by the language processing module 200.

The sentences extracted by the language processing module 200 include sentences containing an opinion and general sentences containing no opinion. Using the opinion/non-opinion classification module 300, the sentences can be classified into the sentences containing an opinion and the sentences containing no opinion.

The opinion/non-opinion classification module 300 can be readily implemented using the above-mentioned common machine learning classifier algorithm.

To be specific, first, a data set consisting of opinions and a data set consisting of fact information are collected. Subsequently, appropriate linguistic features are extracted by performing morpheme analysis or segmentation.

Here, the segmentation is a process of dividing an input sentence in units having meanings. For example, an input sentence [symbol] [symbol] is converted into a resultant sentence

[symbol]

[symbol]

The morpheme analysis is a task of finding which part of speech (POS) information each of the divided units has. For example, the input sentence [symbol] [symbol] is converted into a resultant sentence [symbol] (CTP1; first person pronoun)+ [symbol] (fjb; auxiliary postposition) [symbol] (CMCN; non-predicative common noun)+ [symbol] (fcjo; objective postposition) [symbol] (YBDO; general verb)+ [symbol] (fmoca; auxiliary conjunctive ending) [symbol] (YBDO; general verb)+ [symbol] (fmbtp; past-tense pre-final ending)+ [symbol] (fmofd; declarative final ending).”

Next, a common machine learning classifier algorithm, for example, Naive Bayesian, SVM, or K-NN, is selected to perform learning using the extracted linguistic features.

After the learning is finished, an opinion/non-opinion classification model, that is, the opinion/non-opinion classification module 300 capable of classifying the corresponding data into review data or fact data when a sentence or document is input, can be implemented.

Meanwhile, the opinion/non-opinion classification module 300 configured as described above may be implemented and prepared for each domain-specific data classified using the above-described domain classification model.

The opinion expression classification module 400 serves to classify the linguistic features of the opinion sentences classified by the opinion/non-opinion classification module 300 into affirmative/negative opinion expressions.

In other words, the opinion expression classification module 400 detects and marks affirmative/negative opinion expressions in the input opinion sentences. Meanwhile, the affirmative/negative opinion expressions may be marked in the input sentences directly using the opinion expression classification module 400 without using the opinion/non-opinion classification module 300.

The opinion expression classification module 400 quantifies the degrees of affirmation/negation of all words, such as compounds, general independent words, and phrases, and uses the quantified degrees of affirmation/negation as resources, and is used to generate a machine learning model for detecting affirmative/negative expressions in a sentence.

To be specific, various kinds of reviews such as movie reviews, product reviews, and book reviews are on the Internet, and in these reviews, evaluation results are generally posted together with review sentences.

For example, 10 points may be given with an evaluation “This movie is the greatest masterpiece,” or 1 point may be given with an evaluation “This movie is pure rubbish.” On the basis of such review data, an exemplary embodiment of the present invention calculates affirmative scores and negative scores of respective meaning units, and automatically stores the calculated scores in an opinion vocabulary storage module (not shown).

When input sentences are [symbol] [symbol] −10 points, [symbol] [symbol] [symbol] −9 points, [symbol] [symbol] −9 points┘, the sentence is divided into language units through the language process as follows: [symbol] (SGR; demonstrative determiner) [symbol] (CMCN; non-predicative common noun)+ [symbol] (fjb; auxiliary postposition) [symbol] (SBO; general adverb) [symbol] (YBDO; general verb) [symbol] (fmbtp; past-tense pre-final ending)+ [symbol] (fmofd; declarative final ending)”−10 points, [symbol] (CMCN; non-predicative common noun)+ [symbol] (fjcao; general adverbial postposition) [symbol] (CMCN; non-predicative common noun)+ [symbol] (fjb; auxiliary postposition) [symbol] (SBO; general adverb) [symbol] (YBDO; general verb)+ [symbol] (fmbtp; past-tense pre-final ending)+ [symbol] (fmofd; declarative final ending)”−9 points, and [symbol] (CTP1; first person pronoun)+ [symbol] (fjcao; general adverbial postposition) [symbol] (CMCN; non-predicative common noun) [symbol] (CMCN; non-predicative common noun)+ [symbol] (fjcao; general adverbial postposition) [symbol] YBDO; general verb)+ [symbol] (fmbtp; past-tense pre-final ending)+ [symbol] (fmotgp; past-tense adnominalizing ending) [symbol] (CMCN; non-predicative common noun)”−9 points)┘.

Next, a probability that each of the divided language units will be an affirmative/negative expression is calculated.

For example, input data consists of scores denoting the degrees of affirmation and sentences/documents corresponding to the scores, as shown below. The review data is collected from review sites on which users post affirmative/negative scores and opinions in a general web, as mentioned above.

┌1 point—[“A [symbol] [symbol] “B [symbol] . . . ],

2 point—[“C [symbol] [symbol] “D [symbol] . . . ],

9 point—[“E [symbol] [symbol] “F [symbol] . . . ],

10 point—[“G [symbol] [symbol] “H [symbol] [symbol] . . . ].┘

As mentioned above, the data undergoes segmentation and language-specific morpheme analysis (this can be applied to other languages in the same way). Then, the review data is converted as follows.

┌A(F; foreign letter)+ [symbol] (fjco; objective postposition)+ [symbol] (YBDO; general verb)+ [symbol] (fmbtp; past-tense pre-final ending)+ [symbol] (fmocs; subordinate conjunctive ending)+ [symbol] (cmcPA; active-predicative common noun)+ [symbol] (fph; adjective-derivational affix)+ [symbol] (fmbtp; past-tense pre-final ending)+ [symbol] (fmofd; declarative final ending), B(F; foreign letter)+ [symbol] (fb; auxiliary postposition)+ [symbol] (CMCPS; stative-predicative common noun)+ [symbol] (fpd; a verb-derivational affix)+ [symbol] (fmofd; declarative final ending),

C(F; foreign letter)+ [symbol] (fjco; objective postposition)+ [symbol] (YBDO; general verb)+ [symbol] (fmbtp; past-tense pre-final ending)+ [symbol] (fmocs; subordinate conjunctive ending)+ [symbol] (CMCPA; an active-predicative common noun)+ [symbol] (fph; adjective-derivational affix)+ [symbol] (fmbtp; past-tense pre-final ending)+ [symbol] (fmofd; declarative final ending), D(F; foreign letter)+ [symbol] (fjb; auxiliary postposition)+ [symbol] (CMCN; non-predicative common noun)+ [symbol] (fpd; verb-derivational affix)+ [symbol] (fmofd; declarative final ending),

E(F; foreign letter)+ [symbol] (fjco; objective postposition)+ [symbol] (YBDO; general verb)+ [symbol] (fmbtp; past-tense pre-final ending)+ [symbol] (fmocs; subordinate conjunctive ending) [symbol] (CMCN; non-predicative common noun)+ [symbol] (YBDO; general verb)+ [symbol] (fmbtp; past-tense pre-final ending)+ [symbol] (fmofd; declarative final ending), F(F; foreign letter)+ [symbol] (fjb; auxiliary postposition)+ [symbol] (CMCPA; active-predicative common noun)+ [symbol] (fpd; verb-derivational affix)+ [symbol] (fmofd; declarative final ending),

G(F; foreign letter)+ [symbol] (fjb; auxiliary postposition)+ [symbol] (CMCN; non-predicative common noun)+ [symbol] (fcg; adnominal postposition)+ [symbol] (CMCN; non-predicative common noun)+ [symbol] (fpd; verb-derivational affix)+ [symbol] (fmofd; declarative final ending), H(F; foreign letter)+ [symbol] (fjb; auxiliary postposition)+ [symbol] (CMCN; non-predicative common noun)+ [symbol] (CMCN; non-predicative common noun)+ [symbol] (fjcg; adnominal postposition)+ [symbol] (CMCN; non-predicative common noun)+ [symbol] (fpd; verb-derivational affix)+ [symbol] (fmofd; declarative final ending)┘

Next, using the review data having undergone the language process, affirmation/negation values of the respective language units are obtained.

For example, which degree of affirmation/negation [symbol] (CMCN; non-predicative common noun)” denotes, and how [symbol] (CMCN; non-predicative common noun)” is distributed in respective score bands (1 to 10) are calculated in the form of probability by Equation 7 below.

In Equation 7 below, wⱼ is [symbol] (CMCN; non-predicative common noun).” In this way, wⱼ may denote a combination of a word and the corresponding POS information, or only one word [symbol] without the POS information.

In other words, when the same number of pieces of data are in all the score bands of 1 to 10, an affirmation/negation value of each language unit is calculated by Equation 7 below.

$$Score ( {w}_{j} ) = \frac{{\sum }_{{s}_{i} ∈ S} [ Score ( {s}_{i} ) \times Freq ( {w}_{j} , {s}_{i} ) ]}{{\sum }_{{s}_{i} ∈ S} Freq ( {w}_{j} , {s}_{i} )} \qquad Equation 7$$

Here, S denotes a set of all scores. For example, when movie reviews have 1 to 10 points, S denotes a set of sentences scored 1 to 10 points. Score(sᵢ) denotes an actual score of the corresponding score set. In other words, Score(sᵢ) of a score set of 10 points is 10.

Score(wⱼ) denotes an affirmative/negative score of wⱼ. Freq(wⱼ,sᵢ) denotes a frequency that the word wⱼ is shown in a score set sᵢ.

$${\sum }_{{s}_{i} ∈ S} Freq ( {w}_{j} , {s}_{i} )$$

is the sum of frequencies that the word wⱼ is shown in all the score sets, that is, a frequency that wⱼ is shown in the entire data.

A score of a word can be simply calculated as an average by Equation 7 above. For example, when there are only two 10-point sentences including [symbol] and two 9-point sentences including [symbol] a score of the word [symbol] can be calculated as shown in Equation 8 below.

$$Equation 8$$

$$Score ( \text{-} YBDO ) = \frac{10 \times Freq ( \text{-} YBDO , {s}_{10} ) + 9 \times Freq ( \text{-} YBDO , {s}_{9} )}{Freq ( \text{-} YBDO , {s}_{10} ) + Freq ( \text{-} YBDO , {s}_{9} )} = \frac{10 \times 1 + 9 \times 2}{1 + 2} = 9.333$$

Here, a meaning unit may be a combination of [symbol] and a morpheme “YBDO,” or the word [symbol] only.

Meanwhile, it is uncommon in reality that the same number of sentences are in all score bands. When an average is applied to an environment having one-hundred-thousand pieces of 10-point data and ten-thousand pieces of 1-point data, as shown above, a words, such as [symbol] frequently shown in all the score bands is determined as a considerably affirmative word close to 10 points only because there are many pieces of 10-point data.

For example, when the keyword [symbol] is shown fifty-thousand times in hundred-thousand 10-point sentences and five-thousand times in ten-thousand 1-point sentences, a score of the keyword [symbol] can be calculated as shown in Equation 9 below.

$$Score ( \text{-} CMCN ) = \frac{10 \times 50000 + 1 \times 5000}{50000 + 5000} = 9.1818 \qquad Equation 9$$

In common sense, the keyword [symbol] has a score of 5 or so. However, the keyword [symbol] is shown in 10-point sentences and 1-point sentences at the same ratio, and the above-mentioned problem occurs. Thus, Equation 10 below is required in consideration of the number of pieces of data in the respective score bands.

$$Score ( {w}_{j} ) = \frac{{\sum }_{{s}_{i} ∈ S} [ Score ( {s}_{i} ) \times P ( {w}_{j} \vert {s}_{i} ) ]}{{\sum }_{{s}_{i} ∈ S} P ( {w}_{j} \vert {s}_{i} )} \\ P ( \begin{matrix}{w}_{j} & {s}_{i}\end{matrix} ) = \frac{Freq ( {w}_{j} , {s}_{i} )}{{\sum }_{{w}_{k} ∈ W} Freq ( {w}_{k} , {s}_{i} )} \qquad Equation 10$$

Here, P(wⱼ|sᵢ) is a probability that wⱼ will be shown in a score set sᵢ. For this reason, a frequency of wⱼ in sᵢ is divided by the total number of words in sᵢ,

$${\sum }_{\text{?}} Freq ( {w}_{j} , {s}_{i} )$$

$$\text{?} \text{indicates text missing or illegible when filed}$$

By applying Equation 10 to the problematic situation mentioned above in which the keyword [symbol] is shown fifty-thousand times in one-hundred-thousand 10-point sentences and five-thousand times in ten-thousand 1-point sentences, a score of the keyword [symbol] can be calculated as shown in Equation 11.

$$P ( \text{-} CMCN \vert {s}_{e} ) = \frac{Freq ( \text{-} CMCN , {s}_{10} )}{{\sum }_{\text{?}} Freq ( {w}_{\text{?}} \text{?} )} = \frac{50000}{100000} = 0.5 \\ P ( \text{-} CMCN \vert s ) = \frac{Freq ( \text{-} CMCN , {s}_{1} )}{{\sum }_{\text{?}} Freq ( {w}_{\text{?}} , {s}_{1} )} = \frac{5000}{10000} = 0.5 \\ Score \text{-} CMCN ) = \frac{{\sum }_{\text{?}} Score ( {s}_{\text{?}} ) \times P ( \text{?} )}{{\sum }_{\text{?}} P ( w \text{?} )} = \frac{\text{?}}{0.5 + 0.5} = 5.5 \\ \text{?} \text{indicates text missing or illegible when filed} \qquad Equation 11$$

As mentioned above, by performing normalization using a probability that a word will be shown in each score band, the problem of a score being biased according to a size of the score bands is solved.

Next, affirmative/negative scores of respective meaning units are calculated as described above and stored in the opinion vocabulary storage module.

Meanwhile, when the above-mentioned domain classification module is employed, the opinion expression classification module 400 may be implemented and prepared for data of each domain classified using the above-described domain classification model.

Next, after a probability that each language unit will be an affirmative/negative expression is calculated as described above, a process of marking the language unit as an affirmative/negative opinion expression is performed.

To be specific, when input sentences are [symbol] (SGR; demonstrative determiner) [symbol] (CMCN; non-predicative common noun)+ [symbol] (fjb; auxiliary postposition) [symbol] (SBO; general adverb) [symbol] (YBDO; general verb) [symbol] (fmbtp; past-tense pre-final ending)+ [symbol] (fmofd; declarative final ending)−10 points,

[symbol] (CMCN; a non-predicative common noun)+ [symbol] (fjcao; general adverbial postposition) [symbol] (CMCN; non-predicative common noun)+ [symbol] (fjb; auxiliary postposition) [symbol] (SBO; general adverb) [symbol] (YBDO; general verb)+ [symbol] (fmbtp; past-tense pre-final ending)+ [symbol] (fmofd; declarative final ending)−9 points,

[symbol] (CTP1; first person pronoun)+ [symbol] (fjcao; general adverbial postposition) [symbol] (CMCN; non-predicative common noun) [symbol] (CMCN; non-predicative common noun)+ [symbol] (fjcao; general adverbial postposition) [symbol] (YBDO; general verb)+ [symbol] (fmbtp; past-tense pre-final ending)+ [symbol] (fmotgp; past-tense adnominalizing ending) [symbol] (CMCN; non-predicative common noun)−9 points,

[symbol] (SGR; demonstrative determiner) [symbol] (CMCN; non-predicative common noun)+ [symbol] (fjb; auxiliary postposition) [symbol] (YBDO; general verb)+ [symbol] (fmoca; auxiliary conjunctive ending)+ [symbol] (YA; auxiliary verb)+ [symbol] (fmbtp; past-tense pre-final ending)+ [symbol] (fmofd; declarative final ending)+.(g; mark)—1 point┌,

the sentences are expressed as affirmative/negative opinions as follows.

[symbol] (SGR; demonstrative determiner)/NEUTRAL [symbol] (CMCN; non-predicative common noun)/NEUTRAL+ [symbol] (fjb; auxiliary postposition)/NEUTRAL [symbol] (SBO; general adverb)/NEUTRAL [symbol] (YBDO; general verb)/POSITIVE+ [symbol] (fmbtp; past-tense pre-final ending)/NEUTRAL+ [symbol] (fmofd; declarative final ending)/NEUTRAL−10 points,

[symbol] (CMCN; non-predicative common noun)/NEUTRAL+ [symbol] (fjcao; general adverbial postposition)/NEUTRAL [symbol] (CMCN; non-predicative common noun)/NEUTRAL+ [symbol] (fjb; auxiliary postposition)/NEUTRAL [symbol] (SBO; general adverb)/NEUTRAL [symbol] (YBDO; general verb)/POSITIVE+ [symbol] (fmbtp; past-tense pre-final ending)/NEUTRAL+ [symbol] (fmofd; declarative final ending)/NEUTRAL−9 points,

[symbol] (CTP1; first person pronoun)/NEUTRAL+ [symbol] (fjcao; general adverbial postposition)/NEUTRAL [symbol] (CMCN; non-predicative common noun)/NEUTRAL [symbol] (CMCN; non-predicative common noun)/POSITIVE+ [symbol] (fjcao; general adverbial postposition)/NEUTRAL [symbol] (YBDO; general verb)/POSITIVE+ [symbol] (fmbtp; past-tense pre-final ending)/NEUTRAL+ [symbol] (fmotgp; past-tense adnominalizing ending)/NEUTRAL [symbol] (CMCN; non-predicative common noun)/NEUTRAL−9 points,

[symbol] (SGR; demonstrative determiner)/NEUTRAL [symbol] (CMCN; non-predicative common noun)/NEUTRAL+ [symbol] (fjb; auxiliary postposition)/NEUTRAL [symbol] (YBDO; general verb)/POSITIVE+ [symbol] (fmoca; auxiliary conjunctive ending)/NEUTRAL+ [symbol] (YA; an auxiliary verb)/NEGATIVE+ [symbol] (fmbtp; past-tense pre-final ending)/NEUTRAL+ [symbol] (fmofd; declarative final ending)/NEUTRAL+.(g; mark)/NEUTRAL┘

Among words stored in the opinion vocabulary storage module, words having a specific score or more in a range from 1 point to 10 points are considered affirmative words, and words having less than the specific score are considered negative words.

In the example above, [symbol] (YBDO; general verb)” is considered an affirmative word, and [symbol] (YA; auxiliary verb)” is considered a negative word.

In, affirmative/negative words coexist, and it is difficult to determine whether to mark the whole sentence as affirmation or negation. Such a case frequently occurs in the next step, and thus the opinion expression classification module 400 is implemented using an opinion expression classification and learning model. In other words, the opinion expression classification module 400 serves to detect and mark a portion of a detailed opinion when a sentence is input.

Meanwhile, a portion marked as an opinion word may be directly marked according to whether the corresponding word is affirmative or negative, and also affirmative/negative words may be marked using information about whether the corresponding sentence is an affirmative sentence or negative sentence.

For example, when sentence belongs to a 1-point sentence set, sentence is clearly a negative sentence. Using the information that sentence is a negative sentence, all affirmative/negative words in sentence are marked as negative words. In other words, sentence is marked as follows.

[symbol] (SGR; demonstrative determiner)/NEUTRAL [symbol] (CMCN; non-predicative common noun)/NEUTRAL+ [symbol] (fjb; auxiliary postposition)/NEUTRAL [symbol] (YBDO; general verb)/NEGATIVE+ [symbol] (fmoca; auxiliary conjunctive ending)/NEUTRAL+ [symbol] (YA; auxiliary verb)/NEGATIVE+ [symbol] (fmbtp; past-tense pre-final ending)/NEUTRAL+ [symbol] (fmofd; declarative final ending)/NEUTRAL+.(g; mark)/NEUTRAL

Subsequently, learning is performed to implement the opinion expression classification module 400 using the sentences in which affirmative/negative opinion expressions are marked. At this time, a model used for learning is, for example, hidden Markov model (HMM), maximum entropy model (ME), conditional random field, struct support vector machine, or other machine learning algorithms.

Data input in common from such machine learning algorithm models is (x₁,y₁), . . . , and (xₙ,yₙ). x is a meaning unit, and can be [symbol] (YBDO; general verb),” and so on. y is a label that the corresponding meaning unit can have, and can be “Positive,” “Negative,” “Neutral,” etc. shown above as examples. Also, another label aiding in determining affirmation/negation, such as “strength,” may be added.

In other words, a model desired in an exemplary embodiment of the present invention is a model for estimating a label y attached to input data sequences x. When the data (x₁,y₁), . . . , and (xₙ,yₙ) is given as an input, the above-mentioned models estimate which label yᵢ of xᵢ comes under a specific condition using (xᵢ₋₁,y_{i-1) and (x}ᵢ₊₁,yᵢ₊₁) in front of and behind xᵢ at a specific position, (xᵢ₋₂,yᵢ₋₂) and (xᵢ₊₂,yᵢ₊₂) in front of and behind (xᵢ₋₁,yᵢ₋₁) and (xᵢ₊₁,yᵢ₊₁), and peripheral data continuously expanding in this way together with information about a feature (a POS, a capital letter, an emoticon, etc.) at the position.

When learning is performed using a model as described above, the opinion expression classification module 400 is generated. When a data sequence xᵢ is input, the opinion expression classification module 400 estimates which label sequence yᵢ is generated for the data sequence.

When a sentence is input, a language process is performed, that is, segmentation or morpheme analysis is selectively performed as will be described below. When the data is input to the opinion expression classification module 400, the data can be expressed as follows.

For example, when an input sentence is “ [symbol] (SGR; demonstrative determiner) [symbol] (CMCN; non-predicative common noun)+ [symbol] (fjb; auxiliary postposition) [symbol] (YBDO; general verb)+ [symbol] (fmoca; auxiliary conjunctive ending)+ [symbol] (YA; auxiliary verb)+ [symbol] (fmbtp; past-tense pre-final ending)+ [symbol] (fmofd; declarative final ending)+.(g; mark)—1 point,”

a sentence in which affirmative/negative opinion expressions are classified is expressed as [symbol] (SGR; demonstrative determiner)/NEUTRAL [symbol] (CMCN; non-predicative common noun)/NEUTRAL+ [symbol] (fb; auxiliary postposition)/NEUTRAL [symbol] (YBDO; general verb)/NEGATIVE+ [symbol] (fmoca; auxiliary conjunctive ending)/NEGATIVE+ [symbol] (YA; auxiliary verb)/NEGATIVE+ [symbol] (fmbtp; past-tense pre-final ending)/NEUTRAL+ [symbol] (fmofd; declarative final ending)/NEUTRAL+.(g; mark)/NEUTRAL.”

Here, when opinion words having the same polarity are successively shown in the sentence, the opinion words are considered one opinion expression. Also, when “POSITIVE” and “NEGATIVE” expressions are mainly used for marking, “NEUTRAL” is removed.

In other words, the sentence is expressed as “ [symbol] (SGR; demonstrative determiner) [symbol] (CMCN; non-predicative common noun) [symbol] (fjb; auxiliary postposition)<NEGATIVE> [symbol] (YBDO; general verb)+ [symbol] (fmoca; auxiliary conjunctive ending) [symbol] (YA; auxiliary verb))</NEGATIVE>+ [symbol] (fmbtp; past-tense pre-final ending)+ [symbol] (fmofd; declarative final ending)+.(g; mark).”

Here, <NEGATIVE> denotes a start of an expression, and </NEGATIVE> denotes an end of the expression.

Meanwhile, when an opinion classification learning model is generated using the domain classification module, domain-specific opinion expression classification modules 400 may be generated after review data, in which affirmative/negative expressions are marked, input to the domain classification module is classified.

The indexing server 500 serves to index opinion sentences so that opinion information of the corresponding web documents can be stored in the opinion indexing information storage module 600 according to linguistic features of the opinion sentences classified by the opinion expression classification module 400.

Here, the opinion indexing information storage module 600 serves to store summarized information about the opinion sentences according to the linguistic features of the respective opinion sentences indexed by the indexing server 500 and base information and the opinion information of the web documents as a database (DB).

To be specific, affirmative/negative opinion expressions are detected and marked in input data using the opinion/non-opinion classification module 300 and the opinion expression classification module 400.

For example, when a result in which affirmative/negative opinion expressions are marked is “AA [symbol] <POSITIVE> [symbol] </POSITIVE> [symbol] BB [symbol] <NEGATIVE> [symbol] </NEGATIVE> [symbol] ,” such result data is stored in the opinion indexing information storage module 600 by the indexing server 500.

In general, when a specific web page is searched for and stored, information such as a title, text, opinion-analyzed text, a generation date, a tag, a uniform resource locator (URL), image information, and motion picture information can be stored.

In addition to the information, for example, the number of affirmative expressions in the web page, the number of negative expressions, the overall degree of affirmation/negation, position information about a start and end of each affirmative/negative expression, keyword information about an entity likely to be a target of opinion words, information about a relationship between an entity keyword and an opinion expression, or type information about respective entity keywords can also be stored as opinion information.

When the example data is uploaded with a title “BB review” to a link “http://example.com” at “08/12/2008 23:35:15” together with an image “http://example_test.jpg” and a motion picture “http://example_movie.avi,” the following data information may be stored as a DB in the opinion indexing information storage module 600.

┌1. Title: BB review

2. Text: AA [symbol] [symbol] BB

[symbol]

3. Morpheme-Analyzed Sentence: AA [symbol] [symbol] BB

[symbol]

[symbol]

4. Word-Specific Position Information: AA-1, [symbol] -2, [symbol] -3, [symbol] -4, 11, [symbol] -5, [symbol] -6, 15, .-7, 17, [symbol] -8, BB-9, [symbol] -10, [symbol] -12, [symbol] -13, [symbol] 14

5. Generation Date: 08/12/2008 23:35:15

6. Tag: movie review

7. Image: http://example_test.jpg

8. Motion Picture: http://example_movie.avi

9. Number of Affirmative Expressions: 1 (because the above example has one affirmative expression)

10. Number of Negative Expressions: 1 (because the above example has one negative expression)

11. Overall Degree of Affirmation/Negation of Document: 0 (the number of affirmation expressions 1−the number of negative expressions 1=0, the overall degree of affirmation/negation of the document is determined to be 0)

12. Position of Each Affirmative Expression: (4,4)-(AA/1 [symbol] /2 [symbol] /3 [symbol] 4 [symbol] /5 [symbol] /6 ./7)

13. Position of Each Negative Expression: (11,13)-( [symbol] /8 BB/9 [symbol] /10 [symbol] 11 [symbol] /12 [symbol] /13 [symbol] /14 [symbol] /15 ./16)

14. Entity Keyword: AA, BB

15. Position of Entity Keyword: AA-(1), BB-(9)

16. Type Information about Entity Keyword: (AA, movie), (BB, movie)

17. Information about Relationship between Entity Keyword and Opinion Expression: (AA-(4,4|POSITIVE)), (BB-(11,13|NEGATIVE))┘

Among the pieces of information data, the type information about entity keywords can be obtained using the following two methods together. In a first method, entity DBs are constructed according to predefined types to find type information about each entity. In a second method, a domain of the corresponding web documents and sentences is classified using the domain classification module to find a type.

The information about a relationship between an entity keyword and an opinion expression is found by determining on which entity each opinion expression is dependent using, for example, a Korean parser or subject-verb-object (SVO) analysis, and then is input.

Such information data is stored in the opinion indexing information storage module 600 and then used by the opinion search module 700 later.

The opinion search module 700 serves to receive a specific opinion search keyword and/or type information of a user transmitted through the web server 800, search for indexing information about web documents relating to the specific opinion search keyword and/or type information in association with the indexing server 500 or the indexing information storage module 600, and transfer the searched indexing information to the web server 800, so that the indexing information can be transmitted to the user terminal 900.

In other words, content transferred to the web server 800 may be “Keyword: Nom nom nom, Type: Affirmation/Negation/Opinion.” Among the pieces of type information, “Opinion” is a type resulting in affirmative and negative opinions together. “Affirmation” is a type resulting in an affirmative opinion only. “Negation” is a type resulting in a negative opinion only.

When the specific opinion search keyword and the type information are transferred to the opinion search module 700 in this way, data corresponding to the specific opinion search keyword and the type information is read from the indexing server 500 or the indexing information storage module 600, and results of searching the data according to rankings, such as the order of the amount of opinion or date, are transmitted back to the web server 800.

Here, the searched result information may include, for example, titles, links, titles of the corresponding sites, the number of “Affirmation”s, the number of “Negation”s, the number of “Opinion”s, text content, summarized text snippets, positions of affirmative expressions, and positions of negative expressions.

The summarized text snippets denote parts of searched documents in which the keyword “Nom nom nom” and affirmative/negative opinion expressions are shown together. Unlike a general search, not only the search keyword but also portions corresponding to opinions about the search keyword are marked in summarized text snippets.

At this time, an appropriate advertisement may be selected by an advertisement selection module (not shown), to which advertising data is input by advertisers, and shown together with the search result information relating to the specific search keyword.

The web server 800 serves to receive and transfer the specific opinion search keyword and/or the type information transmitted from the user terminal 900 having accessed the web server 800 via the Internet to the opinion search module 700, receive the opinion search result, that is, indexing information data, from the opinion search module 700, and interface with the user terminal 900 so that the opinion search result can be displayed on a screen of the user terminal 900.

In an exemplary embodiment of the present invention, the opinion search module 700 and the web server 800 are implemented separately from each other, but the present invention is not limited to this case. Alternatively, the opinion search module 700 may be combined with the web server 800 so that the web server 800 can perform all functions.

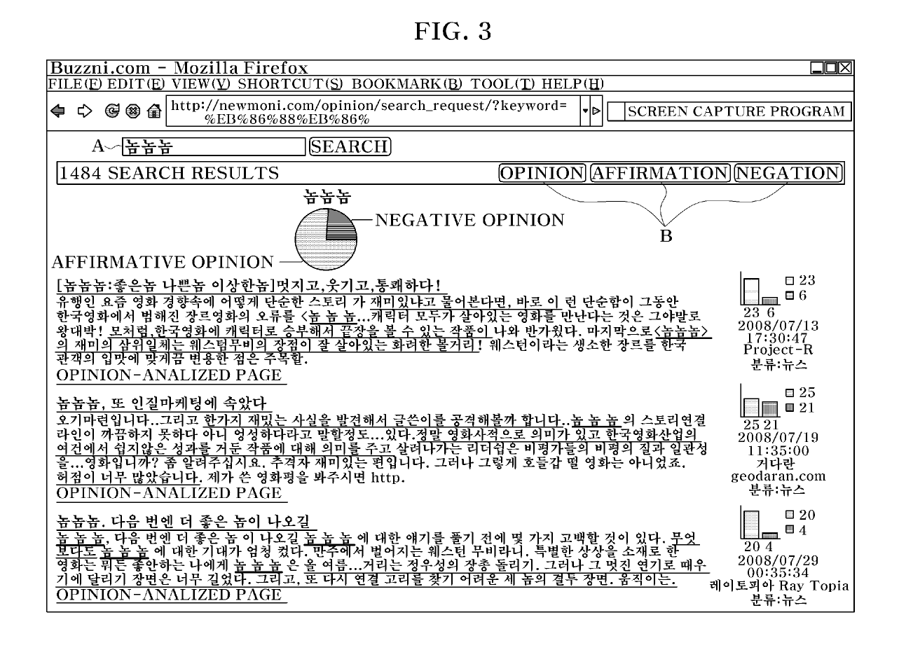

The web server 800 may display all opinions and affirmative/negative opinion content relating to the specific opinion search keyword on the screen of the user terminal 900 to enable selective check of all of the opinions and the affirmative/negative opinion content (see FIGS. 3 to 6).

The web server 800 may display an affirmative/negative opinion expression ratio in all the opinion search results relating to the specific opinion search keyword or in each piece of the opinion information relating to the specific opinion search keyword on the screen of the user terminal 900 (see FIGS. 3 to 6).

The web server 800 may list the opinion search results relating to the specific opinion search keyword in order of importance or time (in chronological or reverse chronological order) and display the list on the screen of the user terminal 900.

The importance may be determined according to the degree of importance that the specific opinion search keyword has in the corresponding web documents and how many opinions the web documents include. In other words, the degree of relationship and the degree of opinion expressions determine the importance. The importance may be calculated over an entire time range or applied to documents corresponding to a time band of a limited specific time range.

The time order may be determined in ascending/descending order according to a sequence in which the corresponding web documents are generated. The opinion search results may be shown in ascending/descending order within the entire time range, or in time order within the specific time range.

The web server 800 not only searches for opinions of other users relating to the specific opinion search keyword but also may display a predetermined opinion input window (not shown) on the screen of the user terminal 900 so that the user can add his/her opinion to the searched opinions as a comment.

Here, the user may add his/her opinion after or without logging in. To log in, personal information, such as sex/age/residence/etc., registered for gaining membership is input. Using such personal information, statistical information about opinion information added to the system may be obtained according to sex/age/residence/etc. and provided to other users at cost/for free.

The web server 800 displays the opinion search results relating to the specific opinion search keyword on the screen of the user terminal 900 with the specific opinion search keyword and affirmative/negative opinion expressions of opinion search result text emphasized by a particular feature (e.g., underlines, bold letter type, various colors, and other features that can be used for emphasis in a web environment), so that the user can easily distinguish the opinion portions (see FIGS. 3 to 6).

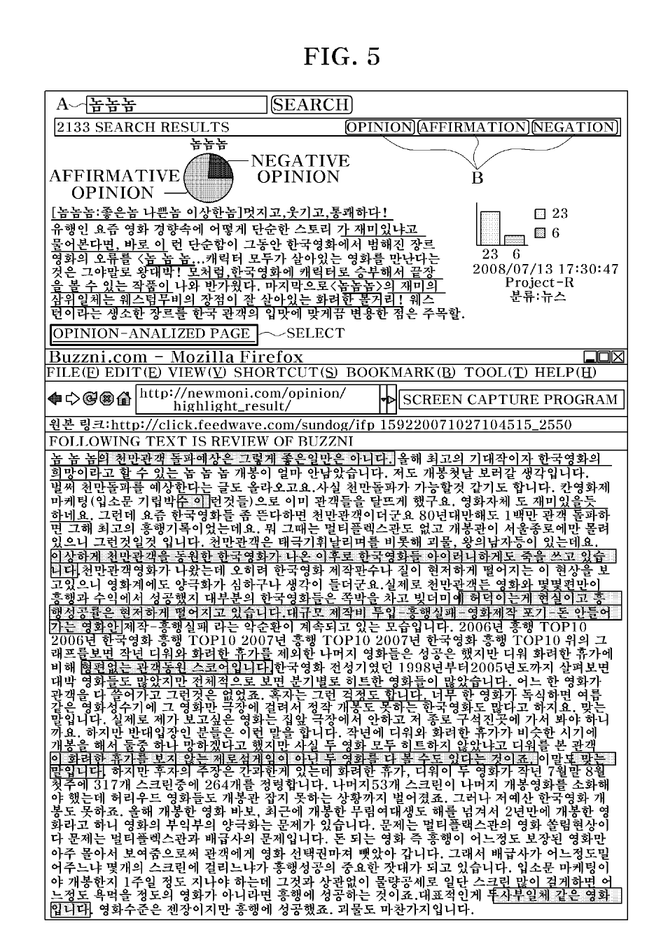

The web server 800 may analyze affirmative/negative opinion expressions of the opinion search result text relating to the specific opinion search keyword according to a selection of the user, and display the opinion search result text [symbol] on the screen of the user terminal 900 with the affirmative/negative opinion expressions emphasized by a specific feature (see FIG. 5).

When the user selects an “opinion-analyzed page” function for a specific piece of the opinion search result text provided through the web server 800, the web server 800 performs opinion analysis on the piece of opinion search result text and then displays the analyzed piece of opinion search result text on the screen of the user terminal 900. At this time, portions determined as “Opinion”/“Affirmation”/“Negation” are emphasized by features, such as a particular color, bold letters, underlines, and other expressions that can be used for emphasis in a web environment, and shown to the user.

The web server 800 may display period-specific variation in affirmation/negation ratio of the opinion search results relating to the specific opinion search keyword in the form of a graph according to the degree of affirmative/negative opinion expressions on the screen of the user terminal 900.

In other words, the web server 800 provides opinion-analyzed statistical data about the specific opinion search keyword input by the user. For example, an X-axis denotes time, and a Y-axis denotes the degree of affirmative/negative opinion expressions (the degree of affirmation/the degree of negation), so that period-specific variation in affirmation/negation ratio relating to the specific opinion search keyword can be seen.

At this time, only a graph relating to the specific opinion search keyword may be shown, or variation in affirmation/negation ratios relating to other specific opinion search keywords belonging to the same category as the specific opinion search keyword may be displayed in the form of a graph together with the graph relating to the specific opinion search keyword.

To constitute such a screen, date information also needs to be stored in the indexing information storage module 600, and the following operation is performed.

First, one cycle is selected according to respective time periods (day/week/month/year), and the number of documents in which the corresponding specific opinion search keyword is determined to be affirmative and negative is found according to the selected cycle.

For example, when 4000 documents having an affirmative opinion about keyword “A” and 1000 documents having a negative opinion about keyword “A” have appeared from July 2008 to August 2008, the degree of affirmation of keyword “A” is “?? [symbol] ” Such a value is displayed on the screen of the user terminal 900 according to respective time periods.

The web server 800 may display an affirmation/negation ratio of the opinion search results relating to the specific opinion search keyword on the screen of the user terminal 900 according to sub-themes of the specific opinion search keyword.

When the user inputs “Anycall,” the degree of affirmation/negation may be classified according to sub-themes of the keyword, for example, sound quality, design, and portability, and displayed according to the sub-themes.

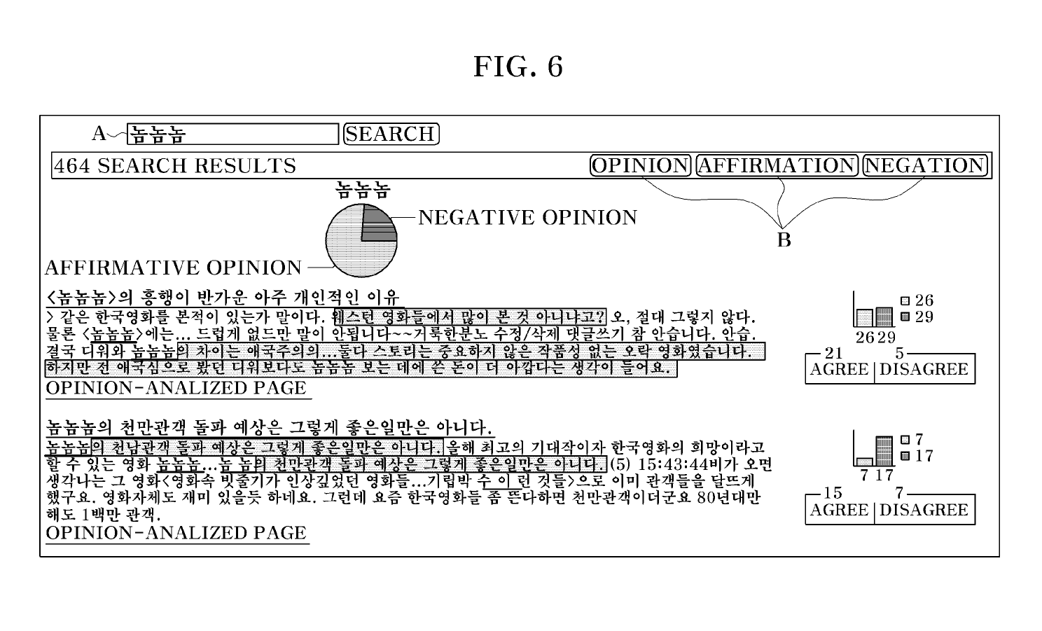

The web server 800 may display agree/disagree buttons on the screen of the user terminal 900 so that the user can select agreement/disagreement with the opinion search result text relating to the specific opinion search keyword (see FIG. 6).

In other words, the user may agree or disagree with the corresponding opinion in the opinion search results. This can be reflected by clicking (selecting) the agree/disagree button on an opinion search result screen as illustrated in FIG. 6 to be described later.

A value obtained by subtracting the number of user disagreements from the number of user agreements is given to each opinion search result ranking as a weight. The higher an agreement-to-disagreement ratio, the higher a ranking becomes. The lower the ratio, the lower the ranking becomes.

When a profit is distributed on the basis of the previously-mentioned advertisement platform, a content provider having many agreements benefits by recommend(wᵢ). In other words, “recommend(wᵢ)=agree(wᵢ)−disagree(wᵢ),” where agree(wᵢ) denotes the number of user agreements, and disagree(wᵢ) denotes the number of user disagreements.

In real time, the web server 800 may monitor and report generation of affirmative/negative opinions relating to the specific opinion search keyword having been registered by the user to the user terminal 900.

In other words, users input specific opinion search keywords and monitor documents containing opinions of other users. When generation of affirmative/negative opinions relating to the specific opinion search keywords having been registered by the users is detected through monitoring, the users are notified of the generation, so that respective companies can monitor negative opinions about themselves and immediately cope with the negative opinions.

Further, when a user inputs a specific opinion search keyword and checks the opinion search results of the specific opinion search keyword, the web server 800 may display an advertisement relating to the specific opinion search keyword on the screen of the user terminal 900.

If several related advertisements can be displayed at this time, the advertisement display sequence may be a large-to-small advertising charge order, or determined using information about a relationship between the keyword and the advertisements. Thus, the user may selectively perform a general opinion search (mix of affirmative and negative opinions)/affirmative opinion search/negative opinion search, and a related advertisement is displayed together with each of the opinion search results.

Documents affirmatively evaluating respective advertising products may be extracted and provided for general online advertising together with respective advertisements. The extracted affirmative opinion documents are shown together with the advertisements using all advertising techniques that can be used online, such as advertising for general keyword search, advertising for opinion search, and general banner advertising.

When the user inputs a general category other than a specific product name as a search keyword, advertising products in the category may be shown as search advertisements. At this time, affirmative/negative opinion values of the respective products and product-specific affirmative opinions may be shown as well.

Each advertiser may also show an advertisement of his/her company for a negative opinion search result. At this time, a general advertisement or explanations for the corresponding opinions may be shown, and a trackback of the explanations may be simultaneously sent to pieces of negative opinion text.

When the user sees the “opinion-analyzed page” function, a related advertisement may be inserted in the screen. Likewise, links of text affirmative to the advertising product may be shown together.

Insertion of an advertisement relating to a specific opinion search keyword will be described in detail. First, an advertiser may input, for example, the following data to set an advertisement.

Advertisement Content: An advertisement link, advertising phrase, advertisement image, etc. are set.

Advertisement Link: http://example_shop.co.kr

Advertising Phrase High-Class Shine phone for Sale at Lowest Price

Image: http://www.example.com/test.jpg

Search keyword: cellular phone, cell phone)

General Search Result Keyword: Shine phone, LG phone, Cyon

Opinion Search Result Keyword: Shine phone, LG phone, Cyon

Affirmative Search Result Keyword: Shine phone, LG phone, Cyon

Negative Search Result Keyword: Anycall, Samsung phone

Analyzed Page Keyword: Shine phone, LG phone, Cyon, Anycall

2. Opinion Search Keyword: The advertiser sets his/her advertisement to be shown when a specific opinion search keyword is input. For example, assuming that “Shine phone” is set as an opinion search keyword, an advertisement of an advertiser who has input “Shine phone” appears when a user inputs the opinion search keyword “Shine phone.”

Here, opinion search results are disposed in an upper part of a screen in order of amount paid by advertisers. Together with advertisements, review text of users affirmative to the corresponding advertising products may also be shown.

3. Opinion Search Result Keyword: The advertiser may set his/her advertisement to be shown when a set opinion search result keyword appears in the opinion search results.

For example, assuming that “JM53” is input as an opinion search result keyword, an advertisement of the corresponding advertiser may be shown when “JM53” appears in opinion search results. In this way, advertisement effect can be maximized.

Here, the advertisement may be disposed above or together with the opinion search results. The advertiser may select in which opinion search result the advertisement will be shown, that is, an opinion search result from among general search/opinion search/affirmative opinion search/negative opinion search results.

Advertising revenue may be shared with reviewers at a predetermined ratio. In this way, an advertisement for a product of a company of the advertiser may be shown when there is text affirmative to the product, or there is text negative to a product of a rival company.

4. Analyzed Page Keyword: Even when one of the opinion search results is selected and a page in which affirmative/negative expressions of the corresponding opinion search result text are analyzed in detail is displayed, the advertiser may show an advertisement in the analyzed page.

At this time, priority is given to a topic that is treated as a main theme in the analyzed page, and advertisements of advertisers who have registered a related topic as a keyword are shown first. Also, the advertisements are shown in order of high-to-low advertising charge.

The advertiser may selectively show advertisements according to whether the analyzed page is affirmative or negative to a keyword of the advertiser overall, which may be determined according to the number of affirmative/negative expressions that are spaced apart, from the keyword input by the advertiser by a predetermined distance or less.

Meanwhile, although not shown in the drawings, advertising revenue may also be shared with a content provider who provides an opinion search result in an exemplary embodiment of the present invention.

To be specific, data input by an advertiser may be the same as the above-described data, and data input by administrators of websites providing opinion search result content may include, for example, names, resident registration numbers, account numbers, site addresses, and addresses.

When the user performs an opinion search, the user inputs an opinion search keyword, for example, “A” in a search window. Subsequently, opinion search results are displayed on the screen of the terminal 900.

Here, advertising revenue of the opinion search keyword is shared with N high-rank opinion search result content providers (the corresponding sites). The content providers having a share of the advertising revenue are persons who have input site information in the search site in advance.

The advertising revenue of the opinion search keyword is shared on the basis of a part-to-whole ratio calculated after weights are given. The content providers are limited to the N pieces of high-rank content of the opinion search results.

When advertising revenue generated by inputting an opinion search keyword once is “C,” a platform provider, that is, an opinion search service provider (search firm), takes a profit at a ratio of “α,” and opinion search result content providers take a profit at a ratio of “1−α,” importance wᵢ of each content provider for revenue sharing is calculated by Equation 12 below.

$${w}_{i} = registered ( w \text{?} ) \text{?} \frac{\begin{matrix}\text{?} click ( {w}_{i} ) * click\_weight + \\ recommend ( {w}_{i} ) \times recomment\_weight\end{matrix}}{rank \text{?} * rank\_weight} \\ \text{?} \text{indicates text missing or illegible when filed} \qquad Equation 12$$

Here, registered(wᵢ) is a function indicating whether or not a wᵢ content provider has been registered as the opinion search service provider, and has the following value:

$$registered ( {w}_{i} ) = \{ \begin{matrix}1 ( Registered Site ) \\ 0 ( unregistered Site )\end{matrix}$$

rankᵢ is a value denoting a search ranking in which content of the wᵢ content provider appears. When the content is shown first, rankᵢ has a value of 1. rank_weight is a function determining importance that will be allocated to opinion search results. The higher a value of rank_weight, the more opinion search result rankings are reflected.

click(wᵢ) is a function indicating whether or not a search user has clicked the corresponding content search results, and has the following value:

$$click ( {w}_{i} ) = \{ \begin{matrix}1 ( Click ) \\ 0 ( Non \text{-} click ) .\end{matrix}$$

click_weight is a constant determining a weight that will be given to whether or not the user has clicked the content search results. recommend(wᵢ) denotes the number of recommendations for the corresponding content made by users.

Here, the number of recommendations includes the number of general recommendations and the number of recommendations relating to a specific opinion search keyword. recommend_weight denotes a weight given to the number of recommendations.

When Equation 12 is used, a site that is frequently clicked by users while shown in a high rank of opinion search results among registered sites, and content that is recommended by many users occupy a large portion of the profit.

Consequently, an advertising charge C that advertisers provide for opinion-search-keyword-specific opinion search results is calculated by Equation 13 below.

C=C×α+C×(1−α) Equation 13

Here, C×a is the profit of an opinion search service provider (search firm), and C×(1−α) is the profit of content providers. A profit of one content provider Profit(wᵢ) is calculated by Equation 14 below.

$$Profit ( {w}_{i} ) = C \times ( 1 - α ) \times \frac{{w}_{j}}{{\sum }_{j = i}^{N} {w}_{j}} \qquad Equation 14$$

The user terminal 900 accesses the web server 800 via a wired or wireless communication network, such as a network or the Internet, and may receive various services provided by the web server 800 through a common web browser.

In general, the user terminal 900 is a computer, for example, a desktop personal computer (PC) or laptop PC. However, the user terminal 900 is not limited to these examples and may be any type of wired or wireless communication device that accesses the web server 800 via the Internet 10 and enables a bidirectional opinion search service.

For example, the user terminal 900 includes mobile terminals performing communication via the wired or portable Internet, such as cellular phones, personal communications service (PCS) phones, and synchronous/asynchronous international mobile telecommunication-2000 (IMT-2000). In addition, the user terminal 900 may comprehensively indicate all wired and wireless appliances/communication devices, such as palm PCs, personal digital assistants (PDAs), smart phones, wireless application protocol (WAP) phones, and mobile video game machines, having a user interface for accessing the web server 800 managing an opinion search service.

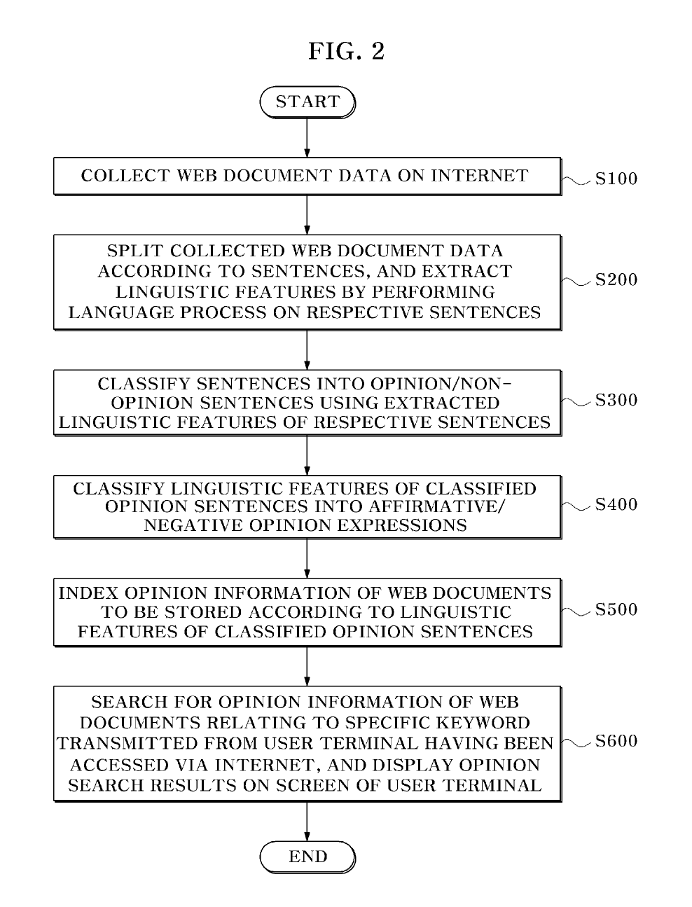

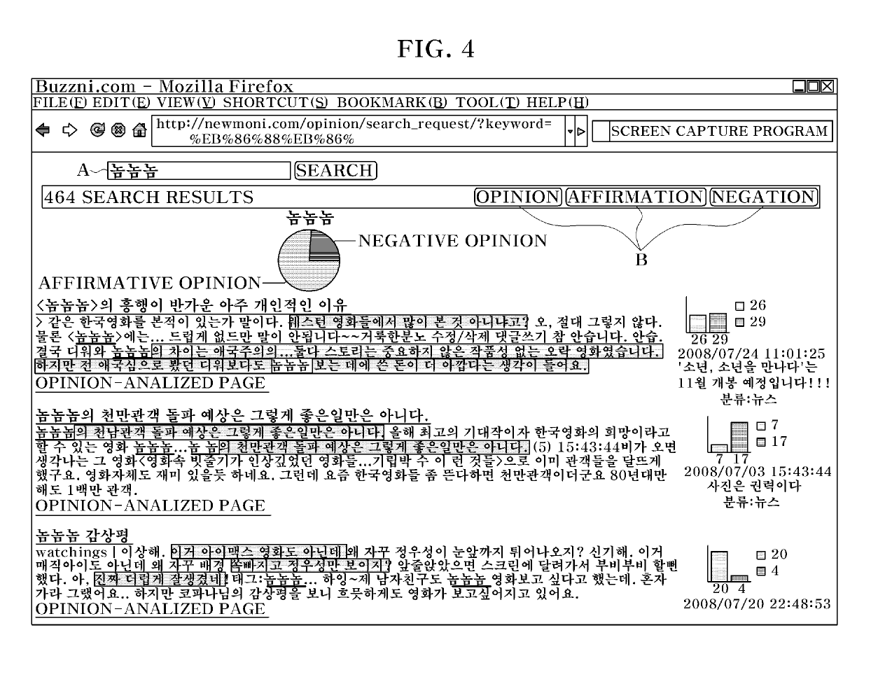

FIG. 2 is an overall flowchart illustrating an Internet-based opinion search method according to an exemplary embodiment of the present invention, and FIGS. 3 to 6 show screens for describing opinion search results applied to an exemplary embodiment of the present invention, FIG. 3 showing a screen displaying opinion search results when a specific opinion search keyword “Nom nom nom” and an affirmative opinion type are selected, FIG. 4 showing a screen displaying opinion search results when the specific opinion search keyword “Nom nom nom” and a negative opinion type are selected, FIG. 5 showing details of an opinion-analyzed page function for opinion search result text relating to the specific opinion search keyword “Nom nom nom,” and FIG. 6 showing a screen having agree/disagree buttons enabling a user to select agreement/disagreement with opinion search result text relating to the specific keyword “Nom nom nom.”

Referring to FIGS. 1 to 6, first, the data collection server 100 collects web document data on the Internet 10 (S100), and then the language processing module 200 splits the web document data collected in step 100 according to sentences, and extracts linguistic features by performing a language process (e.g., morpheme analysis or segmentation) on respective sentences (S200).

Next, the opinion/non-opinion classification module 300 classifies the sentences into opinion/non-opinion sentences using the linguistic features of the respective sentences extracted in step 200 (S300), and then the opinion expression classification module 400 classifies the linguistic features of the opinion sentences classified in step 300 into affirmative/negative opinion expressions (S400).

Subsequently, the indexing server 500 performs indexing so that opinion information of the corresponding web documents can be stored in the opinion indexing information storage module 600 according to the linguistic features of the opinion sentences classified in step 400 (S500).

Here, summarized information about the corresponding opinion sentences according to the linguistic features of the respective opinion sentences indexed in step 500 and base and opinion information of the web documents may be stored as a DB in the opinion indexing information storage module 600.

Next, when a user who wants to search opinions accesses a specific web page providing an opinion search service (e.g., http://buzzni.com) using the user terminal 900 capable of accessing the Internet 10, the web server 800 provides a main search screen having a search input window A for searching opinions and type selection buttons B for selecting an opinion-search type (Opinion/Affirmation/Negation).

In such an opinion search service environment, when the user inputs a desired opinion search keyword in the search input window A and then clicks (selects) one of the type selection buttons B, the web server 800 receives the specific opinion search keyword and/or the opinion search type transmitted from the user terminal 900 having accessed the web server 800 via the Internet 10 and transfers the specific opinion search keyword and/or the opinion search type to the opinion search module 700. Then, the opinion search module 700 searches the indexing server 500 or the opinion indexing information storage module 600 for opinion information of web documents relating to the specific opinion search keyword received from the web server 800, and transfers the opinion search results back to the web server 800.

Subsequently, the web server 800 displays the opinion search results on the specific opinion search keyword transferred from the opinion search module 700 on the screen of the user terminal 900 (S600).

When the opinion search results relating to the specific opinion search keyword are displayed on the screen of the user terminal 900 in step 600, an affirmative/negative opinion expression ratio in all of the opinion search results relating to the specific opinion search keyword or in each piece of the opinion information relating to the specific opinion search keyword may be displayed (see FIGS. 3 to 6).

In step 600, the opinion search results relating to the specific opinion search keyword may be displayed on the screen of the user terminal 900 in order of importance or time.

Here, the importance may be determined according to the degree of relationship and the degree of opinion expressions that the specific keyword has in the corresponding web documents, and applied within an entire time range or a specific time range. The time order may be determined in ascending/descending order according to a sequence in which the corresponding web documents are generated, and applied within the entire time range or the specific time range.

When the opinion search results relating to the specific opinion search keyword are displayed on the screen of the user terminal 900 in step 600, an opinion input window (not shown) may be displayed so that the opinion search user can add an opinion about opinion content of the web documents relating to the specific opinion search keyword as a comment.

In step 600, the opinion search results relating to the specific opinion search keyword may be displayed on the screen of the user terminal 900 with the specific opinion search keyword and the affirmative/negative expressions emphasized by a particular feature (e.g., underlines, bold letter type, or various colors) (see FIGS. 3 to 6).

When the opinion search results relating to the specific opinion search keyword are displayed on the screen of the user terminal 900 in step 600, the “opinion-analyzed page” function may be provided to each piece of opinion search result text (see FIGS. 3 to 6).

When the user selects the “opinion-analyzed page” function corresponding to a piece of opinion search result text, the web server 800 may analyze affirmative/negative opinion expressions of the opinion search result text, and then display the opinion search result text with the affirmative/negative opinion expressions emphasized by at least one feature of, for example, underlines, bold letter type, and various colors (see FIG. 5).

When the opinion search results relating to the specific opinion search keyword are displayed on the screen of the user terminal 900 in step 600, period-specific variation in affirmation/negation ratio may be displayed in the form of a graph according to the degree of affirmative/negative opinion expressions (see FIGS. 3 to 6).

When the opinion search results relating to the specific opinion search keyword are displayed on the screen of the user terminal 900 in step 600, an affirmation/negation ratio may be displayed according to sub-themes of the specific opinion search keyword.

When the opinion search results relating to the specific opinion search keyword are displayed on the screen of the user terminal 900 in step 600, agree/disagree buttons may be displayed on the screen of the user terminal 900 so that the user can select agreement/disagreement with the opinion search result text relating to the specific opinion search keyword (see FIG. 6).

Additionally, after step 600, a step in which the web server 800 monitors and reports generation of affirmative/negative opinions relating to the specific opinion search keyword having been registered by the user to the user terminal 900 in real time may be further included.

Meanwhile, the Internet-based opinion search method according to an exemplary embodiment of the present invention can also be embodied as computer-readable codes on a computer-readable recording medium. The computer-readable recording medium includes any kind of recording device storing data which can be read by computer systems.

Examples of computer-readable recording media include a read-only memory (ROM), random-access memory (RAM), compact disc (CD)-ROM, magnetic tape, hard disk, floppy disk, mobile storage device, non-volatile memory (flash memory), and optical data storage, and further include an implementation in carrier waves (e.g., transmission over the Internet).

Also, the computer-readable recording medium may be may be distributed among computer systems connected through a computer communication network and stored and executed as a code that can be read in a de-centralized method.

An Internet-based opinion search system and method according to an exemplary embodiment of the present invention have been described above, but the present invention is not limited to the exemplary embodiment. The present invention can be modified in various ways and implemented within the scope of the claims, the detailed description and the appended drawings, and the modifications will fall within the scope of the present invention.

For example, the Internet-based opinion search system and method are implemented based on Korean in an exemplary embodiment of the present invention, but the present invention is not limited to Korean. The Internet-based opinion search system and method may be implemented based on various languages, for example, English, Japanese, and Chinese.

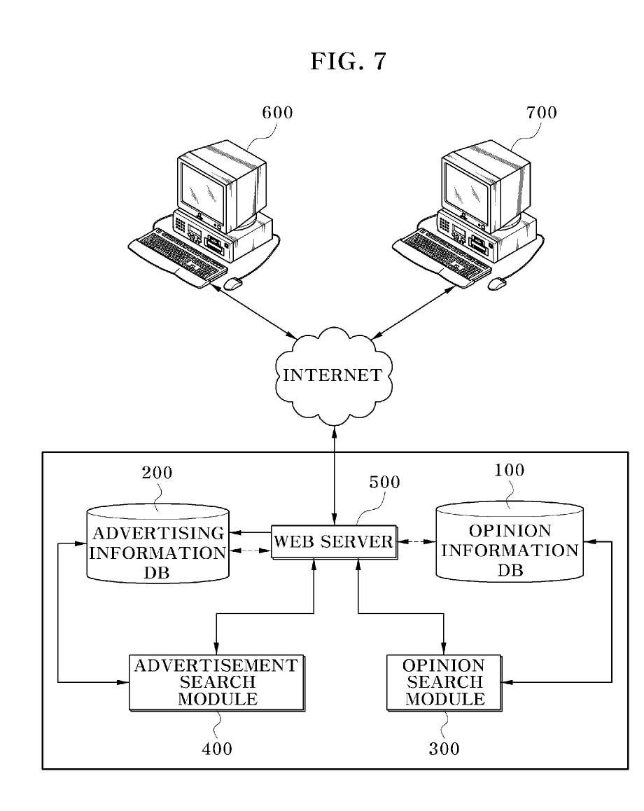

FIG. 7 is an overall block diagram of an Internet-based opinion search and advertising service system according to an exemplary embodiment of the present invention.

Referring to FIG. 7, an Internet-based opinion search and advertising service system according to an exemplary embodiment of the present invention schematically includes an opinion information DB 100, an advertising information DB 200, an opinion search module 300, an advertisement search module 400, a web server 500, a user terminal 600, an advertiser terminal 700, and so on.

Here, the opinion information DB 100 serves to store opinion information of the corresponding web documents as a DB according to linguistic features of opinion sentences. In other words, summarized information about the opinion sentences according to the linguistic features of the respective opinion sentences and base information and the opinion information of the web documents may be stored as a DB in the opinion information DB 100.

The base and opinion information of the web documents may include at least one piece of information among titles, text, opinion-analyzed text, generation dates, tags, URLs, images, motion pictures, the number of affirmative/negative expressions, the overall degree of affirmation/negation, position information about a start and end of each affirmative/negative expression, keyword information about an entity likely to be a target of opinion words, information about a relationship between an entity keyword and an opinion expression, and type information about respective entity keywords.

For example, when a result in which affirmative/negative opinion expressions are marked is “AA [symbol] <POSITIVE> [symbol] </POSITIVE> [symbol] BB [symbol] <NEGATIVE> [symbol] <NEGATIVE> [symbol] ”, such result data is stored in the opinion information DB 100.

In general, when a specific web page is searched for and stored, information such as a title, text, opinion-analyzed text, a generation date, a tag, a URL, image information, and motion picture information can be stored.

In addition to the information, for example, the number of affirmative expressions in the web page, the number of negative expressions, the overall degree of affirmation/negation, position information about a start and end of each affirmative/negative expression, keyword information about an entity likely to be a target of opinion words, information about a relationship between an entity keyword and an opinion expression, or type information about respective entity keywords can also be stored as opinion information.

When the example data is uploaded with a title “BB review” to a link “http://example.com” at “08/12/2008 23:35:15” together with an image “http://example_test.jpg” and a motion picture “http://example_movie.avi,” the following data information may be stored as a DB in the opinion information DB 100.

1. Title: BB review

2. Text: AA [symbol] [symbol] BB [symbol] .

3. Morpheme-Analyzed Sentence: AA [symbol] [symbol] BB

[symbol]

[symbol]

4. Word-Specific Position Information: AA-1, [symbol] -2, [symbol] -3, [symbol] -4, 11, [symbol] -5, [symbol] -6, 15, .-7, 17, [symbol] -8, BB-9, [symbol] -10, [symbol] -12, [symbol] -13, [symbol] -14

5. Generation Date: 2008/08/12 23:35:15

6. Tag: movie review

7. Image: http://example_test.jpg

8. Motion Picture: http://example_movie.avi

9. Number of Affirmative Expressions: 1 (because the above example has one affirmative expression)

10. Number of Negative Expressions: 1 (because the above example has one negative expression)

11. Overall Degree of Affirmation/Negation of Document: 0 (the number of affirmation expressions 1−the number of negative expressions 1=0, the overall degree of affirmation/negation of the document is determined to be 0)

12. Position of Each Affirmative Expression: (4,4)-(AA/1 [symbol] /2 [symbol] /3 [symbol] /4 [symbol] /5 [symbol] /6 ./7)

13. Position of Each Negative Expression: (11,13)-( [symbol] /8 BB/9 [symbol] 10 [symbol] /11 [symbol] /12 [symbol] /13 [symbol] /14 [symbol] /15 ./16)

14. Entity Keyword: AA, BB

15. Position of Entity Keyword: AA-(1), BB-(9)

16. Type Information about Entity Keyword: (AA, movie), (BB, movie)

17. Information about Relationship between Entity Keyword and Opinion Expression: (AA-(4,4|POSITIVE)), (BB-(11,13|NEGATIVE))┘

Among the pieces of information data, the type information about entity keywords can be obtained using the following two methods together. In a first method, entity DBs are constructed according to predefined types to find type information about each entity. In a second method, a domain of the corresponding web documents and sentences is classified using a domain classification module (not shown) to find a type.

The information about a relationship between an entity keyword and an opinion expression is found by determining on which entity each opinion expression is dependent using, for example, a Korean parser or SVO analysis, and then is input. Such information data is stored in the opinion information DB 100 and then used by the opinion search module 300 later.

The opinion information stored in the opinion information DB 100 may be obtained by splitting web document data on the Internet according to sentences, performing a language process on respective sentences to extract linguistic features, classifying the sentences into opinion/non-opinion sentences using the extracted linguistic features of the respective sentences, classifying the linguistic features of the classified opinion sentences into affirmative/negative opinion expressions, and indexing the opinion information of the corresponding web documents according to linguistic features of the classified opinion sentences.

The opinion information stored in the opinion information DB 100 is disclosed in detail in Korean Patent Application No. 2008-93125 (System and Method for Searching Opinion Using Internet) previously filed by the present applicant, and thus detailed description of the opinion information will be omitted.

The advertising information DB 200 serves to store keyword-specific advertising information as a DB. In other words, posting-area-specific advertising information is stored as a DB in the advertising information DB 200 according to settings of advertisers.

At least one piece of advertising information among advertising link, advertising phrase, and advertising image information according to search keywords previously set by advertisers, the search result keywords, or resultant keywords of opinion search types may be databased and stored as the advertising information.

The opinion search types may be one selected from all opinion content, affirmative/negative opinion content, and analysis content of affirmative/negative opinion expressions of the opinion search result text.

To be specific, first, an advertiser may input, for example, the following data through the advertiser terminal 700, thereby setting an advertisement.

1. Advertisement Content: An advertisement link, advertising phrase, advertisement image, etc. are set.

Advertisement Link: http://example_shop.co.kr

Advertising Phrase High-Class Shine Phone for Sale at Lowest Price

Image: http://www.example.com/test.jpg

Search keyword: cellular phone, cell phone

General Search Result Keyword: Shine phone, LG phone, Cyon

Opinion Search Result Keyword: Shine phone, LG phone, Cyon

Affirmative Search Result Keyword: Shine phone, LG phone, Cyon

Negative Search Result Keyword: Anycall, Samsung phone

Analyzed Page Keyword: Shine phone, LG phone, Cyon, Anycall

2. Opinion Search Keyword: The advertiser sets his/her advertisement to be shown when a specific opinion search keyword is input. For example, assuming that “Shine phone” is set as an opinion search keyword, an advertisement of an advertiser who has input “Shine phone” appears when a user inputs the opinion search keyword “Shine phone.”

Here, advertisement content is disposed above opinion search results in order of amount paid by advertisers. Together with advertisements, review text of users affirmative to the corresponding advertising products may also be shown.

3. Opinion Search Result Keyword: The advertiser may set his/her advertisement to be shown when a set opinion search result keyword appears in the opinion search results.

For example, assuming that “JM53” is input as an opinion search result keyword, an advertisement of the corresponding advertiser may be shown when “JM53” appears in opinion search results. In this way, advertisement effect can be maximized.

Here, the advertisement may be disposed above or together with the opinion search results. The advertiser may select in which opinion search result the advertisement will be shown, that is, an opinion search result from among general search/opinion search/affirmative opinion search/negative opinion search results.

Advertising revenue may be shared with reviewers at a predetermined ratio. In this way, an advertisement for a product of a company of the advertiser may be shown when there is text affirmative to the product, or there is text negative to a product of a rival company.

4. Analyzed Page Keyword: Even when one of the opinion search results is selected and a page in which affirmative/negative expressions of the corresponding opinion search result text are analyzed in detail is displayed, the advertiser may show an advertisement in the analyzed page.

At this time, priority is given to a topic that is treated as a main theme in the analyzed page, and advertisements of advertisers who have registered a related topic as a keyword are shown first. Also, the advertisements are shown in order of high-to-low advertising charge.

The advertiser may selectively show advertisements according to whether the analyzed page is affirmative or negative to a keyword of the advertiser overall, which may be determined according to the number of affirmative/negative expressions that are spaced apart from the keyword input by the advertiser by a predetermined distance or less.

Advertising information data set by respective advertisers is stored as a DB in the advertising information DB 200 through the web server 500 having been accessed via the Internet.

The opinion search module 300 serves to receive a specific opinion search keyword and/or type information of a user transmitted through the web server 500, search for opinion information of web documents relating to the specific opinion search keyword and/or type information in association with the opinion information DB 100, and transfer the searched opinion information to the web server 500, so that the opinion information can be transmitted to the user terminal 600.

In other words, content transferred by the user terminal 600 to the web server 500 may be “Keyword: Nom nom nom, Type: Affirmation/Negation/Opinion.” Among the pieces of type information, “Opinion” is a type resulting in affirmative and negative opinions together. “Affirmation” is a type resulting in an affirmative opinion only. “Negation” is a type resulting in a negative opinion only.

When the specific opinion search keyword and the type information are transferred to the opinion search module 300 in this way, the opinion search module 300 reads data corresponding to the specific opinion search keyword and the type information from the opinion information DB 100, and transmits results of searching the data according to rankings, such as the order of the amount of opinion or date back to the web server 500,

Here, the searched result information may include, for example, titles, links, titles of the corresponding sites, the number of “Affirmation”s, the number of “Negation”s, the number of “Opinion”s, text content, summarized text snippets, positions of affirmative expressions, and positions of negative expressions.

The summarized text snippets denote parts of searched documents in which the keyword “Nom nom nom” and affirmative/negative opinion expressions are shown together. Unlike a general search, not only the search keyword but also portions corresponding to opinions about the search keyword are marked in summarized text snippets.

The advertisement search module 400 serves to receive the specific opinion search keyword and/or type information of the user transmitted through the web server 500, search for advertising information relating to the specific opinion search keyword and/or type information in association with the advertising information DB 200, and transfer the searched advertising information to the web server 500, so that the advertising information can be transmitted to the user terminal 600.

In other words, content transferred by the user terminal 600 to the web server 500 may be “Keyword: Nom nom nom, Type: Affirmation/Negation/Opinion.” Among the pieces of type information, “Opinion” is a type resulting in affirmative and negative opinions together. “Affirmation” is a type resulting in an affirmative opinion only. “Negation” is a type resulting in a negative opinion only.

In other words, the advertisement search module 400 searches for advertisements relating to the specific keyword input through the web server 500 in association with the advertising information DB 200, and transmits advertising information of the search results to the web server 500 so that the advertising information can be displayed on a screen of the user terminal 600 according to previously set posting areas.

The web server 500 serves to receive and transfer the specific opinion search keyword and/or the type information transmitted from the user terminal 600 having accessed the web server 500 via the Internet to the opinion search module 300 and the advertisement search module 400, receive the opinion search result data and the advertisement search result data from the opinion search module 300 and the advertisement search module 400 respectively, and interface with the user terminal 600 so that opinion search result text and related advertising information can be displayed on the screen of the user terminal 600.

In an exemplary embodiment of the present invention, the opinion search module 300, the advertisement search module 400, and the web server 500 are implemented separately from each other, but the present invention is not limited to this case. Alternatively, the opinion search module 300 and the advertisement search module 400 may be combined with the web server 500 so that the web server 500 can perform all functions.

The web server 500 may display all opinions and affirmative/negative opinion content relating to the specific opinion search keyword on the screen of the user terminal 600 to enable selective check of all of the opinions and the affirmative/negative opinion content.

The web server 500 may display an affirmative/negative opinion expression ratio in all the opinion search results relating to the specific opinion search keyword or in each piece of the opinion information relating to the specific opinion search keyword together with related advertising information on the screen of the user terminal 600.

The web server 500 may list the opinion search results relating to the specific opinion search keyword in order of importance or time (in chronological or reverse chronological order) and display the list on the screen of the user terminal 600.

The importance may be determined according to the degree of importance that the specific opinion search keyword has in the corresponding web documents and how many opinions the web documents include. In other words, the degree of relationship and the degree of opinion expressions determine the importance. The importance may be calculated over an entire time range or applied to documents corresponding to a time band of a limited specific time range.

The time order may be determined in ascending/descending order according to a sequence in which the corresponding web documents are generated. The opinion search results may be shown in ascending/descending order within the entire time range, or in time order within the specific time range.

The web server 500 not only searches for opinions of other users relating to the specific opinion search keyword but may also display a predetermined opinion input window (not shown) on the screen of the user terminal 600 so that the user can add his/her opinion to the searched opinions as a comment.

Here, the user may add his/her opinion after or without logging in. To log in, personal information, such as sex/age/residence/etc., registered for gaining membership is input. Using such personal information, statistical information about opinion information added to the system may be obtained according to sex/age/residence/etc. and provided to other users at cost/for free.

The web server 500 displays the opinion search results relating to the specific opinion search keyword on the screen of the user terminal 600 with the specific opinion search keyword and affirmative/negative opinion expressions of opinion search result text emphasized by a particular feature (e.g., underlines, bold letter type, various colors, and other expressions that can be used for emphasis in a web environment), so that the user can easily distinguish the opinion portions.

The web server 500 may analyze affirmative/negative opinion expressions of the opinion search result text relating to the specific opinion search keyword according to a selection of the user, and display the opinion search result text together with related advertising information on the screen of the user terminal 600 with the analyzed affirmative/negative opinion expressions emphasized by a specific feature.

When the user selects an “opinion-analyzed page” function for a specific piece of the opinion search result text provided through the web server 500, the web server 500 performs opinion analysis on the piece of opinion search result text and then displays the analyzed piece of opinion search result text together with related advertising information on the screen of the user terminal 600. At this time, portions determined as “Opinion”/“Affirmation”/“Negation” are emphasized by features, such as a particular color, bold letters, underlines, and other expressions that can be used for emphasis in a web environment, and shown to the user.

The web server 500 may display period-specific variation in affirmation/negation ratio of the opinion search results relating to the specific opinion search keyword in the form of a graph according to the degree of affirmative/negative opinion expressions on the screen of the user terminal 600.

In other words, the web server 500 provides opinion-analyzed statistical data about the specific opinion search keyword input by the user. For example, an X-axis denotes time, and a Y-axis denotes the degree of affirmative/negative opinion expressions (the degree of affirmation/the degree of negation), so that period-specific variation in affirmation/negation ratio relating to the specific opinion search keyword can be seen.

At this time, only a graph relating to the specific opinion search keyword may be shown, or variation in affirmation/negation ratios relating to other specific opinion search keywords belonging to the same category as the specific opinion search keyword may be displayed in the form of a graph together with the graph relating to the specific opinion search keyword.

To constitute such a screen, date information also needs to be stored in the opinion information DB 100, and the following operation is performed.

First, one cycle is selected according to respective time periods (day/week/month/year), and the number of documents in which the specific opinion search keyword is determined to be affirmative and negative is found according to the selected cycle.

For example, when 4000 documents having an affirmative opinion about keyword “A” and 1000 documents having a negative opinion about keyword “A” have appeared from July 2008 to August 2008, the degree of affirmation of keyword “A” is “?? [symbol] ” Such a value is displayed on the screen of the user terminal 600 according to respective time periods.

The web server 500 may display an affirmation/negation ratio of the opinion search results relating to the specific opinion search keyword on the screen of the user terminal 600 according to sub-themes of the specific opinion search keyword.

When the user inputs “Anycall,” the degree of affirmation/negation may be classified according to sub-themes of the keyword, for example, sound quality, design, and portability, and displayed according to the sub-themes.

The web server 500 may display agree/disagree buttons on the screen of the user terminal 600 so that the user can select agreement/disagreement with the opinion search result text relating to the specific opinion search keyword.

In other words, the user may agree or disagree with the corresponding opinion in the opinion search results. This can be reflected by clicking (selecting) the agree/disagree button on an opinion search result screen.

A value obtained by subtracting the number of user disagreements from the number of user agreements is given to each opinion search result ranking as a weight. The higher an agreement-to-disagreement ratio, the higher a ranking becomes. The lower the ratio, the lower the ranking becomes.

When a profit is distributed on the basis of the previously-mentioned advertisement platform, a content provider having many agreements benefits by recommend(wᵢ). In other words, “recommend(wᵢ)=agree(wᵢ)−disagree(wᵢ),” where agree(wᵢ) denotes the number of user agreements, and disagree(wᵢ) denotes the number of user disagreements.

In real time, the web server 500 may monitor and report generation of affirmative/negative opinions relating to the specific opinion search keyword having been registered by the user to the user terminal 600.

In other words, users input specific opinion search keywords and monitor documents containing opinions of other users. When generation of affirmative/negative opinions relating to the specific opinion search keywords having been registered by the users is detected through monitoring, the users are notified of the generation, so that respective companies can monitor negative opinions about themselves and immediately cope with the negative opinions.

In particular, when a user inputs a specific opinion search keyword and checks the opinion search results of the specific opinion search keyword, the web server 500 may display advertising information relating to the specific opinion search keyword on the screen of the user terminal 600.

If several related advertisements can be displayed at this time, the advertisement display sequence may be a large-to-small advertising charge order, or determined using information about a relationship between the keyword and the advertisements. Thus, the user may selectively perform a general opinion search (mix of affirmative and negative opinions)/affirmative opinion search/negative opinion search, and a related advertisement is displayed together with each of the opinion search results.

Documents affirmatively evaluating respective advertising products may be extracted and provided for general online advertising together with respective advertisements. The extracted affirmative opinion documents are shown together with the advertisements using all advertising techniques that can be used online, such as advertising for general keyword search, advertising for opinion search, and general banner advertising.

When the user inputs a general category other than a specific product name as a search keyword, advertising products in the category may be shown as search advertisements. At this time, affirmative/negative opinion values of the respective products and product-specific affirmative opinions may be shown as well.

Each advertiser may also show an advertisement of his/her company for a negative opinion search result. At this time, a general advertisement or explanations for the corresponding opinions may be shown, and a trackback of the explanations may be simultaneously sent to pieces of negative opinion text.

When the user sees the “opinion-analyzed page” function, a related advertisement may be inserted in the screen. Likewise, links of text affirmative to the advertising product may be shown together.

In particular, in an exemplary embodiment of the present invention, advertising revenue may also be shared with a content provider who provides an opinion search result.

In other words, the web server 500 may provide a part of advertising revenue to a content provider who provides each piece of opinion search result text according to a search ranking of the corresponding content, whether or not a search user selects the content, and the number of recommendations on the content.

To be specific, data input by an advertiser may be the same as the above-described data, and data input by administrators of websites providing opinion search result content may include, for example, names, resident registration numbers, account numbers, site addresses, and addresses.

When the user performs an opinion search, the user inputs an opinion search keyword, for example, “A” in a search window. Subsequently, opinion search results are displayed on the screen of the terminal 600.

Here, advertising revenue of the opinion search keyword is shared with N high-rank opinion search result content providers (the corresponding sites). The content providers having a share of the advertising revenue are persons who have input site information in the search site in advance.

The advertising revenue of the opinion search keyword is shared on the basis of a part-to-whole ratio calculated after weights are given. The content providers are limited to the N pieces of high-rank content of the opinion search results.

When advertising revenue generated by inputting an opinion search keyword once is “C,” a platform provider, that is, an opinion search service provider (search firm) takes a profit at a ratio of “α,” and opinion search result content providers take a profit at a ratio of “1−α,” importance wᵢ of each content provider for revenue sharing is calculated by Equation 12 below.

$${w}_{i} = registered ( w \text{?} ) \text{?} \frac{\begin{matrix}\text{?} click ( {w}_{i} ) * click\_weight + \\ recommend ( {w}_{i} ) \times recomment\_weight\end{matrix}}{rank \text{?} * rank\_weight} \\ \text{?} \text{indicates text missing or illegible when filed} \qquad Equation 15$$

Here, registered(wᵢ) is a function indicating whether or not a wᵢ content provider has been registered as the opinion search service provider, and has the following value:

$$registered ( {w}_{i} ) = \{ \begin{matrix}1 ( Registered Site ) \\ 0 ( unregistered Site )\end{matrix}$$

rankᵢ is a value denoting a search ranking in which content of the wᵢ content provider appears. When the content is shown first, rankᵢ has a value of 1. rank_weight is a function determining importance that will be allocated to opinion search results. The higher a value of rank_weight, the more opinion search result rankings are reflected.

click(wᵢ) is a function indicating whether or not a search user has clicked the corresponding content search results, and has the following value:

$$click ( {w}_{i} ) = \{ \begin{matrix}1 ( Click ) \\ 0 ( Non \text{-} click ) .\end{matrix}$$

click_weight is a constant determining a weight that will be given to whether or not the user has clicked the content search results. recommend(wᵢ) denotes the number of recommendations for the corresponding content made by users.

Here, the number of recommendations includes the number of general recommendations and the number of recommendations relating to a specific opinion search keyword. recommend_weight denotes a weight given to the number of recommendations.

When Equation 15 is used, a site that is frequently clicked by users while shown in a high rank of opinion search results among registered sites, and content that is recommended by many users occupy a large portion of the profit.

Consequently, an advertising charge C that advertisers provide for opinion-search-keyword-specific opinion search results is calculated by Equation 16 below.

C=C×α+C×(1−α) Equation 16

Here, C×α is the profit of an opinion search service provider (search firm), and C×(1−α) is the profit of content providers. A profit of one content provider Profit(wᵢ) is calculated by Equation 17 below.

$$Profit ( {w}_{i} ) = C \times ( 1 - α ) \times \frac{{w}_{j}}{{\sum }_{j = i}^{N} {w}_{j}} \qquad Equation 17$$

The user terminal 600 and the advertiser terminal 700 access the web server 500 via a wired or wireless communication network, such as a network or the Internet, and may receive various services provided by the web server 500 through a common web browser.

In general, the user terminal 600 and the advertiser terminal 700 are computers, for example, desktop PCs or laptop PCs. However, the user terminal 600 and the advertiser terminal 700 are not limited to these examples and may be any type of wired or wireless communication devices that access the web server 500 via the Internet and enable a bidirectional opinion search service.

For example, the user terminal 600 and the advertiser terminal 700 include mobile terminals performing communication via the wired or portable Internet, such as cellular phones, PCS phones, and synchronous/asynchronous IMT-2000. Additionally, the user terminal 600 and the advertiser terminal 700 may comprehensively indicate all wired and wireless appliances/communication devices, such as palm PCs, PDAs, smart phones, WAP phones, and mobile video game machines, having a user interface for accessing the web server 500 managing an opinion search service.

Meanwhile, although not shown in the drawings, settlement, authentication, account, etc. services relating to advertising charge can be readily implemented between advertisers and content providers by a common electronic commerce system, etc., and detailed description of these services will be omitted.

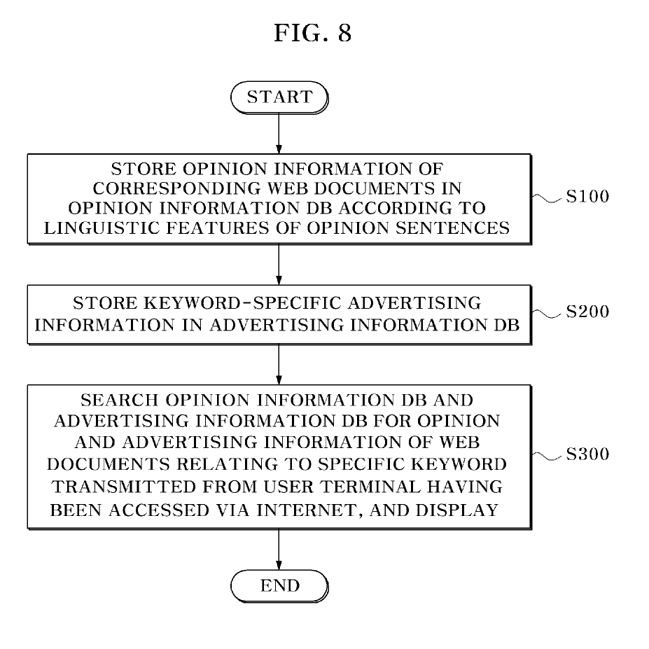

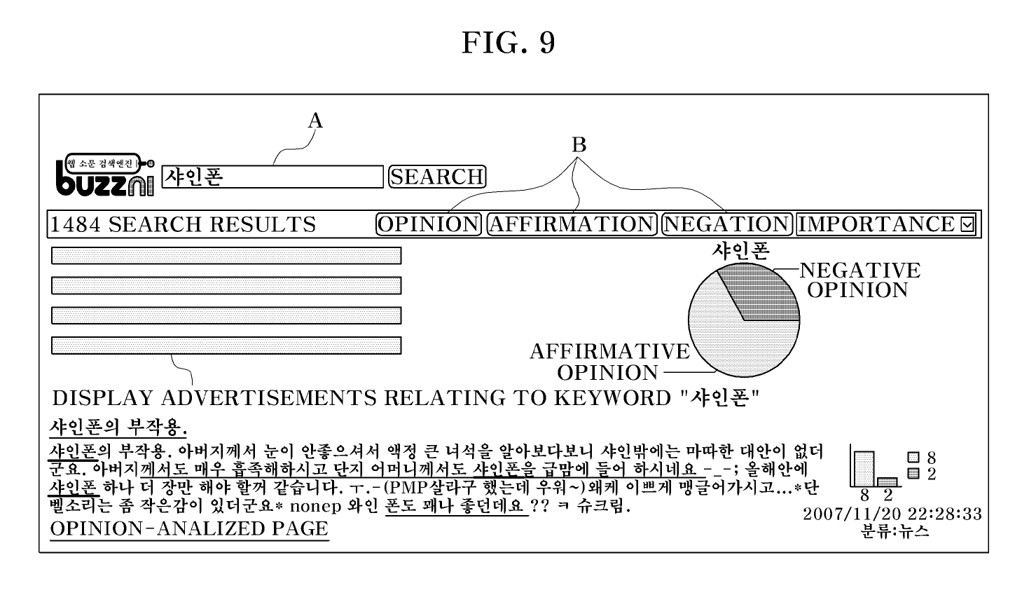

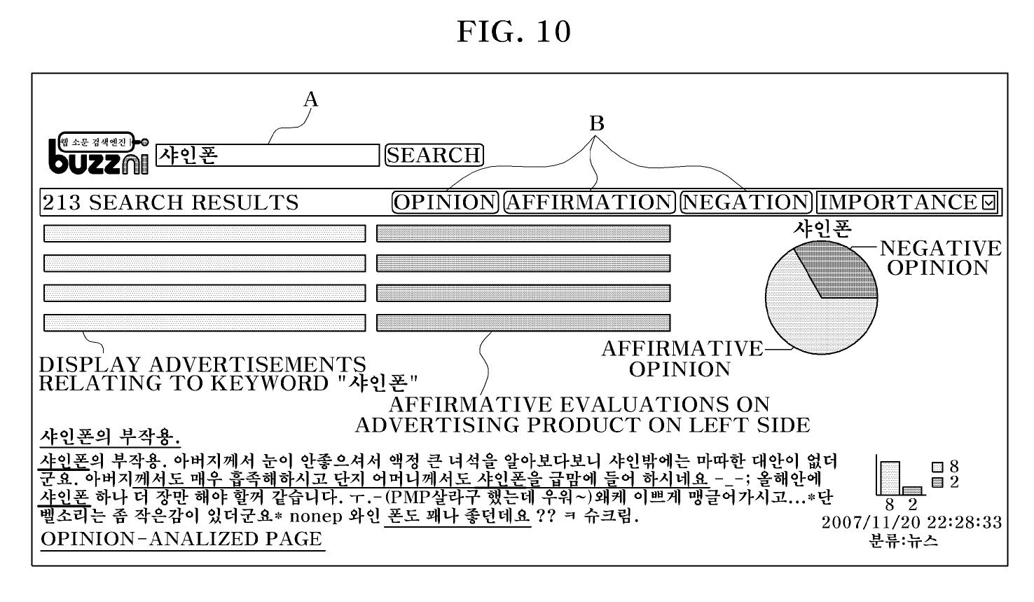

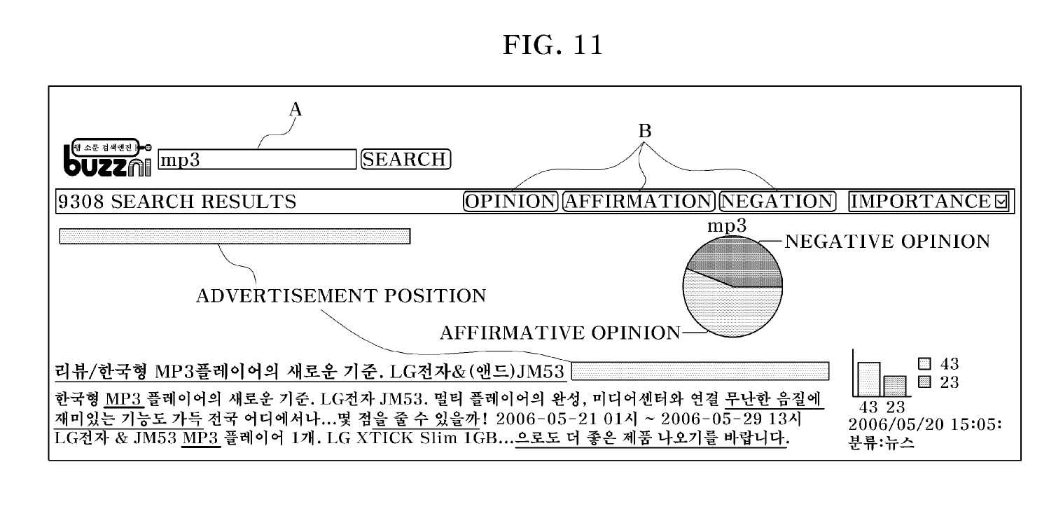

FIG. 8 is an overall flowchart illustrating an Internet-based opinion search and advertising service method according to an exemplary embodiment of the present invention, and FIGS. 9 to 12 show screens for describing opinion search and advertising service results applied to another exemplary embodiment of the present invention.

Referring to FIGS. 7 to 12, first, opinion information of the corresponding web documents is stored in the opinion information DB 100 according to linguistic features of opinion sentences (S100), and keyword-specific advertising information is stored in the advertising information DB 200 (S200).

Next, when a user who wants to search opinions accesses a specific web page providing an opinion search and advertising service (e.g., http://buzzni.com) using the user terminal 600 capable of accessing the Internet 10, the web server 500 provides a main search screen having a search input window A for searching opinions and type selection buttons B for selecting an opinion-search type (Opinion/Affirmation/Negation).

In such an opinion search and advertising service environment, when the user inputs a desired opinion search keyword in the search input window A and then clicks (selects) one of the type selection buttons B, the web server 500 receives the specific opinion search keyword and/or the opinion search type transmitted from the user terminal 600 having accessed the web server 500 via the Internet and transfers the specific opinion search keyword and/or the opinion search type to the opinion search module 300 and the advertisement search module 400. Then, the opinion search module 300 and the advertisement search module 400 respectively search the opinion information DB 100 and the advertising information DB 200 for opinion information of web documents relating to the specific opinion search keyword received from the web server 500 and advertising information relating to the opinion information, and transfer the opinion search results and the advertising information back to the web server 500.

Subsequently, the web server 500 appropriately displays opinion search result text relating to the specific opinion search keyword and related advertising information respectively obtained by the opinion search module 300 and the advertisement search module 400 on the screen of the user terminal 600 according to previously-set reference information (e.g., an advertisement insertion sequence or position) (S300).

In step 100, summarized information about the opinion sentences according to the linguistic features of the respective opinion sentences and base information and the opinion information of the corresponding web documents may be stored as a DB in the opinion information DB 100.

In step 100, the opinion information stored in the opinion information DB 100 may be obtained by splitting web document data on the Internet according to sentences, performing a language process on respective sentences to extract linguistic features, classifying the sentences into opinion/non-opinion sentences using the extracted linguistic features of the respective sentences, classifying the linguistic features of the classified opinion sentences into affirmative/negative opinion expressions, and indexing the opinion information of the corresponding web documents according to linguistic features of the classified opinion sentences.

In step 200, at least one piece of advertising information among advertising link, advertising phrase, and advertising image information according to search keywords previously set by advertisers, the search result keywords, or resultant keywords of opinion search types may be stored as a DB in the advertising information DB 200. The opinion search types may be, for example, one selected from all opinion content, affirmative/negative opinion content, and analysis content of affirmative/negative opinion expressions of the opinion search result text.

In step 300, the opinion search result text relating to the specific keyword is displayed on the screen of the user terminal 600 together with the related advertising information, so that all opinions and affirmative/negative opinion content relating to the specific keyword can be selectively checked. An affirmative/negative opinion expression ratio in all the opinion search results relating to the specific keyword or in each piece of the opinion information relating to the specific keyword may be displayed on the screen of the user terminal 600 together with the related advertising information (see FIGS. 9 to 12).

When the opinion search result text relating to the specific keyword is displayed on the screen of the user terminal 600 together with the related advertising information in step 300, affirmative opinion content relating to the specific keyword may be displayed on the screen of the user terminal 600 together with the related advertising information, or an input window (not shown) may be displayed on the screen of the user terminal 600 so that the opinion search user can add an opinion about negative opinion content of the web documents relating to the specific opinion keyword as a comment.

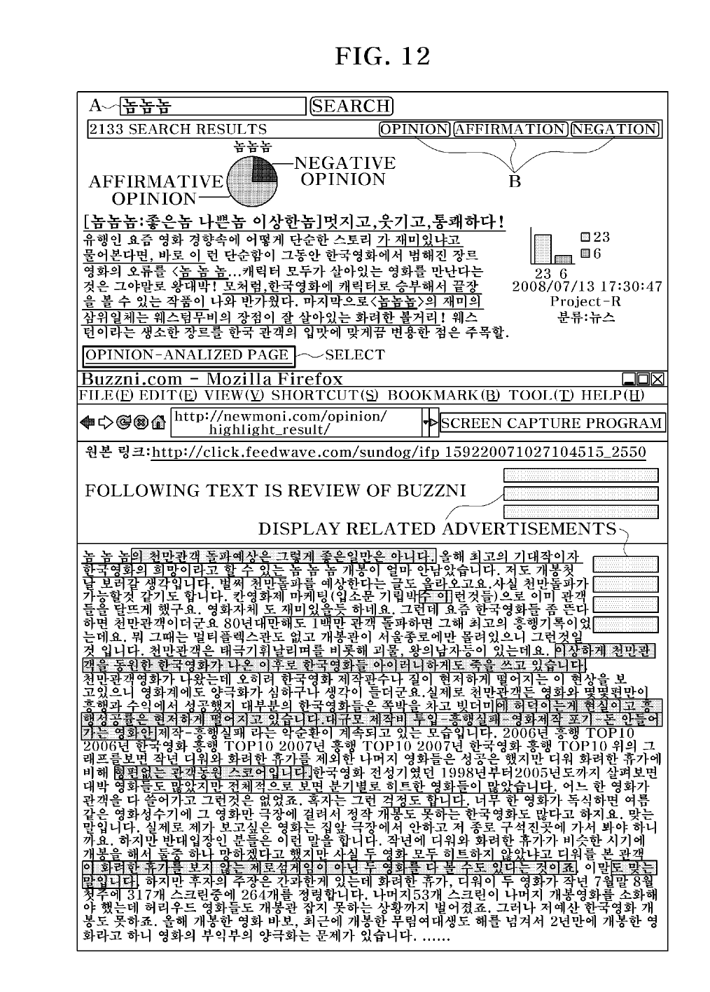

When the opinion search result text relating to the specific keyword is displayed on the screen of the user terminal 600 together with the related advertising information in step 300, affirmative/negative opinion expressions of the opinion search result text relating to the specific keyword may be analyzed according to a selection of the user, and the analyzed opinion expressions may be displayed on the screen of the user terminal 600 together with the related advertising information (see FIG. 12).

Additionally, after step 300, a step of providing a part of advertising revenue to a content provider who provides each piece of opinion search result text according to a search ranking of the corresponding content, whether or not the search user selects the content, and the number of recommendations on the content may be further included.

Meanwhile, the Internet-based opinion search and advertising service method according to an exemplary embodiment of the present invention can also be embodied as computer-readable codes on a computer-readable recording medium. The computer-readable recording medium includes any kind of recording device storing data which can be read by computer systems.

Examples of computer-readable recording media include a ROM, RAM, CD-ROM, magnetic tape, hard disk, floppy disk, mobile storage device, non-volatile memory (flash memory), and optical data storage, and further include an implementation in carrier waves (e.g., transmission over the Internet).

Also, the computer-readable recording medium may be distributed among computer systems connected through a computer communication network and stored and executed as a code that can be read in a de-centralized method.

An Internet-based opinion search and advertising service system and method according to an exemplary embodiment of the present invention have been described above, but the present invention is not limited to the exemplary embodiment. The present invention can be modified in various ways and implemented within the scope of the claims, the detailed description and the appended drawings, and the modifications will fall within the scope of the present invention.

For example, the Internet-based opinion search and advertising service system and method are implemented based on Korean in an exemplary embodiment of the present invention, but the present invention is not limited to Korean. The Internet-based opinion search and advertising service system and method may be implemented based on various languages, for example, English, Japanese, and Chinese.

While the invention has been shown and described with reference to certain exemplary embodiments thereof, it will be understood by those skilled in the art that various changes in form and details may be made therein without departing from the spirit and scope of the invention as defined by the appended claims.

1. An Internet-based opinion search system, comprising:
a first server configured to collect web document data on the Internet;
a language processing module configured to split the collected web document data according to sentences, and extract linguistic features by performing a language process on respective sentences;
an opinion/non-opinion classification module configured to classify the sentences into opinion/non-opinion sentences using the extracted linguistic features of the respective sentences;
an opinion expression classification module configured to classify the linguistic features of the classified opinion sentences into affirmative/negative opinion expressions;
a second server configured to index the classified opinion sentences to store opinion information of corresponding web documents according to the linguistic features of the classified opinion sentences; and
a web server configured to receive a specific keyword transmitted from a user terminal having accessed the web server via the Internet, search for opinion information of web documents relating to the specific keyword in association with the second server, and display opinion search results on a screen of the user terminal.

2. The Internet-based opinion search system of claim 1, further comprising a data storage module configured to extract at least one piece of information data among required text, image and video information from the web document data collected by the first server and store the extracted data.

3. The Internet-based opinion search system of claim 1, wherein the language processing module splits general document data including previously-set opinion/non-opinion sentences together with the collected web document data according to sentences, and extracts linguistic features by performing a language process on respective sentences.

4. The Internet-based opinion search system of claim 1, further comprising an opinion indexing information storage module configured to store summarized information about the opinion sentences according to the linguistic features of the respective opinion sentences indexed by the second server and base information and the opinion information of the web documents as a database (DB).

5. The Internet-based opinion search system of claim 1, wherein the web server displays all opinions and affirmative/negative opinion content relating to the specific keyword on the screen of the user terminal to enable selective check of all of the opinions and the affirmative/negative opinion content, or displays an affirmative/negative opinion expression ratio in all of the opinion search results relating to the specific keyword or in each piece of the opinion information relating to the specific keyword on the screen of the user terminal.

6. The Internet-based opinion search system of claim 1, wherein the web server lists the opinion search results relating to the specific keyword in order of importance or time and displays the list on the screen of the user terminal,
wherein the importance is determined according to degree of relationship and degree of opinion expressions that the specific keyword has in the web documents and applied within an entire time range or a specific time range, and
the time order is determined in ascending/descending order according to a sequence in which the web documents are generated and applied within the entire time range or the specific time range.

7. The Internet-based opinion search system of claim 1, wherein the web server displays an opinion input window on the screen of the user terminal to enable a corresponding opinion search user to add an opinion about opinion content of the web documents relating to the specific keyword as a comment, or displays the opinion search results relating to the specific keyword on the screen of the user terminal with the specific keyword and affirmative/negative opinion expressions emphasized by a particular feature.

8. The Internet-based opinion search system of claim 1, wherein the web server analyzes affirmative/negative opinion expressions of opinion search result text relating to the specific keyword according to a selection of a corresponding user, and displays the opinion search result text on the screen of the user terminal with the affirmative/negative opinion expressions emphasized by a particular feature.

9. The Internet-based opinion search system of claim 1, wherein the web server displays period-specific variation in affirmation/negation ratio of the opinion search results relating to the specific keyword in the form of a graph according to degree of affirmative/negative opinion expressions on the screen of the user terminal, or displays an affirmation/negation ratio of the opinion search results relating to the specific keyword according to sub-themes of the specific keyword on the screen of the user terminal.

10. The Internet-based opinion search system of claim 1, wherein the web server displays agree/disagree buttons on the screen of the user terminal to enable a corresponding user to select agreement/disagreement with opinion search result text relating to the specific keyword, or monitors and reports generation of affirmative/negative opinions relating to the specific keyword having been registered by the user to the user terminal in real time.

11. An Internet-based opinion search and advertising service system, comprising:
an opinion information database (DB) configured to store opinion information of corresponding web documents according to linguistic features of opinion sentences;
an advertising information DB configured to store keyword-specific advertising information; and
a web server configured to receive a specific keyword transmitted from a user terminal having accessed the web server via the Internet, search for opinion information of web documents relating to the specific keyword and advertising information relating to the specific keyword in association with the opinion information DB and the advertising information DB, and display the related advertising information together with opinion search result text on a screen of the user terminal.

12. The Internet-based opinion search and advertising service system of claim 11, wherein the opinion information stored in the opinion information DB is obtained by splitting web document data on the Internet according to sentences, performing a language process on respective sentences to extract linguistic features, classifying the sentences into opinion/non-opinion sentences using the extracted linguistic features of the respective sentences, classifying the linguistic features of the classified opinion sentences into affirmative/negative opinion expressions, and indexing the opinion information of the corresponding web documents according to the linguistic features of the classified opinion sentences.

13. The Internet-based opinion search and advertising service system of claim 11, wherein at least one piece of advertising information among advertising link, advertising phrase, and advertising image information according to search keywords previously set by advertisers, search result keywords or resultant keywords of opinion search types is databased and stored as the advertising information.

14. The Internet-based opinion search and advertising service system of claim 11, wherein the web server displays all opinions and affirmative/negative opinion content relating to the specific keyword on the screen of the user terminal to enable selective check of all of the opinions and the affirmative/negative opinion content, and displays the related advertising information on the screen of the user terminal together with an affirmative/negative opinion expression ratio in all opinion search results relating to the specific keyword or in each piece of the opinion information relating to the specific keyword.

15. The Internet-based opinion search and advertising service system of claim 11, wherein the web server provides a part of advertising revenue to a content provider who provides the opinion search result text according to a search ranking of corresponding content, whether or not a search user selects the content, and a number of recommendations on the content.

16. An Internet-based opinion search method, comprising:
(a) collecting web document data on the Internet;
(b) splitting the collected web document data according to sentences, and performing a language process on respective sentences to extract linguistic features;
(c) classifying the sentences into opinion/non-opinion sentences using the extracted linguistic features of the respective sentences;
(d) classifying linguistic features of the classified opinion sentences into affirmative/negative opinion expressions;
(e) indexing the classified opinion sentences to store opinion information of corresponding web documents according to the linguistic features of the classified opinion sentences; and
(f) searching for opinion information of web documents relating to a specific keyword transmitted from a user terminal having been accessed via the Internet, and displaying opinion search results on a screen of the user terminal.

17. The Internet-based opinion search method of claim 16, wherein step (b) includes splitting general document data including previously-set opinion/non-opinion sentences according to sentences together with the collected web document data, and extracting linguistic features by performing a language process on respective sentences.

18. The Internet-based opinion search method of claim 16, wherein, when the opinion search results relating to the specific keyword are displayed on the screen of the user terminal, step (f) includes displaying all opinions and affirmative/negative opinion content relating to the specific keyword to enable selective check of all of the opinions and the affirmative/negative opinion content, or displaying an affirmative/negative opinion expression ratio in all of the opinion search results relating to the specific keyword or in each piece of the opinion information relating to the specific keyword on the screen of the user terminal.

19. The Internet-based opinion search method of claim 16, wherein step (f) includes displaying the opinion search results relating to the specific keyword in order of importance or time when the opinion search results relating to the specific keyword are displayed on the screen of the user terminal,
wherein the importance is determined according to degree of relationship and degree of opinion expressions that the specific keyword has in the web documents and applied within an entire time range or a specific time range, and
the time order is determined in ascending/descending order according to a sequence in which the web documents are generated and applied within the entire time range or the specific time range.

20. The Internet-based opinion search method of claim 16, wherein, when the opinion search results relating to the specific keyword are displayed on the screen of the user terminal, step (f) includes displaying an opinion input window to enable a corresponding opinion search user to add an opinion about opinion content of the web documents relating to the specific keyword as a comment, or displaying the opinion search results relating to the specific keyword with the specific keyword and affirmative/negative opinion expressions emphasized by a particular feature.

21. The Internet-based opinion search method of claim 16, wherein, when the opinion search results relating to the specific keyword are displayed on the screen of the user terminal, step (f) includes analyzing affirmative/negative opinion expressions of opinion search result text relating to the specific keyword according to a selection of a corresponding user and then displaying the opinion search results relating to the specific keyword with the affirmative/negative opinion expressions emphasized by a particular feature, or displaying period-specific variation in affirmation/negation ratio in the form of a graph according to degree of affirmative/negative opinion expressions.

22. An Internet-based opinion search and advertising service method, comprising:
(a) storing opinion information of corresponding web documents in an opinion information database (DB) according to linguistic features of opinion sentences;
(b) storing keyword-specific advertising information in an advertising information DB; and
(c) searching the opinion information DB and the advertising information DB for opinion information of web documents and advertising information relating to a specific keyword transmitted from a user terminal having been accessed via the Internet, and displaying the related advertising information together with opinion search result text on a screen of the user terminal.

23. The Internet-based opinion search and advertising service method of claim 22, wherein step (a) includes splitting web document data on the Internet according to sentences, performing a language process on respective sentences to extract linguistic features, classifying the sentences into opinion/non-opinion sentences using the extracted linguistic features of the respective sentences, classifying the linguistic features of the classified opinion sentences into affirmative/negative opinion expressions, indexing the opinion information of the corresponding web documents according to the linguistic features of the classified opinion sentences, and storing the opinion information in the opinion information DB.

24. The Internet-based opinion search and advertising service method of claim 22, wherein, when the related advertising information is displayed on the screen of the user terminal together with the opinion search result text relating to the specific keyword, step (c) includes displaying all opinions and affirmative/negative opinion content relating to the specific keyword on the screen of the user terminal to enable selective check of all of the opinions and the affirmative/negative opinion content, and displaying the related advertising information on the screen of the user terminal together with an affirmative/negative opinion expression ratio in all opinion search results relating to the specific keyword or in each piece of the opinion information relating to the specific keyword.

25. The Internet-based opinion search and advertising service method of claim 22, wherein, when the related advertising information is displayed on the screen of the user terminal together with the opinion search result text relating to the specific keyword, step (c) includes displaying the related advertising information on the screen of the user terminal together with affirmative opinion content relating to the specific keyword, or displaying an input window on the screen of the user terminal to enable a corresponding search user to provide an explanation for negative opinion content of the web documents relating to the specific keyword.

26. The Internet-based opinion search and advertising service method of claim 22, wherein, when the related advertising information is displayed on the screen of the user terminal together with the opinion search result text relating to the specific keyword, step (c) includes analyzing affirmative/negative opinion expressions of the opinion search result text relating to the specific keyword according to a selection of a corresponding user, and displaying the related advertising information on the screen of the user terminal together with the analyzed opinion expressions.

27. The Internet-based opinion search and advertising service method of claim 22, further comprising, after step (c), providing a part of advertising revenue to a content provider who provides the opinion search result text according to a search ranking of corresponding content, whether or not a search user selects the content, and the number of recommendations on the content.
